(19) United States
(12) Patent Application Publication
(10) Pub. No.: US 2009/0274256 A1
(43) Pub. Date: Nov. 5, 2009

(54) HYDROGEN-LITHIUM FUSION DEVICE, METHOD AND APPLICATIONS

(76) Inventors: Stephen A. Lipinski, Palo Alto, CA (US); Hubert M. Lipinski, Palo Alto, CA (US)

Correspondence Address: HAYNES BEFFEL & WOLFELD LLP, P O BOX 366, HALF MOON BAY, CA, 94019, US

(21) Appl. No.: 12/371,227

(22) Filed: Feb. 13, 2009

Related U.S. Application Data
(63) Continuation-in-part of application No. PCT/US07/18256, filed on Aug. 17, 2007.
(60) Provisional application No. 60/822,902, filed on Aug. 18, 2006.
(60) Provisional application No. 60/845,117, filed on Sep. 15, 2006.
(60) Provisional application No. 60/893,818, filed on Mar. 8, 2007.
(60) Provisional application No. 60/893,823, filed on Mar. 8, 2007.
(60) Provisional application No. 60/893,826, filed on Mar. 8, 2007.

(51) Int. Cl. G21K 5/08

(52) U.S. Cl. 376/151

(57) ABSTRACT

The Hydrogen-Lithium Fusion Device is a revolutionary new device that consists of a proton accelerator, lithium foil target, and a target holder of specified geometry. The invention enables a proton-lithium fusion efficiency that is close to 100% and the fusion byproducts to exit the lithium target without transferring significant fusion energy to the target as heat. Particular aspects of the present invention are described in the claims, specification and drawings.

### RELATED APPLICATIONS

This application claims priority as a continuation-in-part of PCT application no. PCT/US07/18256, filed Aug. 17, 2007, which claims the benefit of U.S. provisional applications 60/822,902; 60/845,117; 60/893,818; 60/893,823; and 60/893,826. These related applications are incorporated by reference.

### BACKGROUND OF THE INVENTION

The most comprehensive summary of prior research in hydrogen-lithium fusion is offered by Herb et al. (Herb, R. G., Parkinson, D. B., Kerst, D. W. 1935. Yield of Alpha-Particles from Lithium Films Bombarded by Protons. Physical Review 48: 118-124) who cite 3 previous experiments involving hydrogen/lithium fusion as well as their own experimental results. Herb's paper concludes that at proton energies comparable to those used by these inventors during recent experiments in Huntsville, Ala., very little fusion takes place. Herb's data show a fusion efficiency of 0.334×10⁻⁷ compared to 1.0 for perfect fusion—that is, for every 30,000,000 protons in the beam, only one will fuse with lithium to produce a detectable alpha particle.

In this section, the inventors introduce hydrogen-lithium fusion and contrast it with traditional hot and cold fusion efforts. In relation to the current fusion research programs that are in process today, a Hydrogen-Lithium Fusion Device made according to the present invention has a very different implementation for achieving nuclear fusion. The Hydrogen-Lithium Fusion Device is believed to enable a rate of fusion efficiency that is close to 100% and the energy of the fusion byproducts to be harnessed without heat effects.

Applicants wish to emphasize that in this application various theories will be discussed and positions will be taken with regard to various aspects of the invention. These statements and positions will be based upon the novel theories discussed below, such as in paragraphs [0032] through [0040]; [0123] through [0149] and [0151] through [0260], and also on the experiments conducted by the inventors and discussed in paragraphs [0042] through [0062] and [0070] through [0122]. Statements that do not find support in the experiments are necessarily theoretical and not based upon specific experimental findings. For example, applicants' belief that the rate of fusion efficiency will be close to 100% is based upon the novel theories associated with the invention and upon the belief that the experimental results tend to support this position. Also, the experiments discussed at paragraphs [0151] through [0177] have not been conducted and the inventors' projected results describe what is expected to occur.

Research institutes and laboratories that work on conventional (hot) fusion have been taking a very different approach. This approach has been to mimic the fusion reaction inside a star by using deuterium and tritium ions. The goal of these reactions is to harness the heat energy from extra neutrons that are expelled at high velocity from this reaction type. To date, no experiment has been able to harness energy or sustain a fusion reaction past the break even point of energy consumption.

To the inventors' knowledge, no research institute has ever been able to utilize the two-step method for hot hydrogen fusion in a practical and economical way. The second step, which involves the heating of water from the fusion reaction, has not been attempted because the first step for conventional fusion containment has not been adequate.

So-called cold fusion does not require the extremely high temperatures and plasma containment necessary for hot fusion. Rather, cold fusion relies on electrolytic techniques to promote fusion using heavy water (D₂O). Cold fusion approaches are still being investigated. To the inventors' knowledge, there have been no definitive positive results from cold fusion.

A Hydrogen-Lithium Fusion Device, hot fusion, and cold fusion approaches are summarized and compared below.

COMPARISON OF FUSION APPROACHES

| Hydrogen-Lithium Fusion | | |
|---|---|---|
| Device | Hot Fusion | Cold Fusion |
| Fuel: | Fuel: | Fuel: |
| Hydrogen gas and lithium | Deuterium and tritium | Heavy water (D₂O) |
| Fusion Creation: | Fusion Creation: | Fusion Creation: |
| Accelerated hydrogen ion | Magnetic pulsing and laser | D₂O electrolysis |
| beam striking a lithium | heating | |
| target | | |
| Temperature: | Temperature: | Temperature: |
| Room temperature | 100 million ° C. | Room temperature |
| Containment: | Containment: | Containment: |
| Vacuum chamber | Magnetic bottle | None |
| Protective Shielding: | Protective Shielding: | Protective Shielding: |
| Helium ions | Neutrons | Neutrons |

The opportunities presented by a new approach to fusion are virtually limitless. They include propulsion and power generation. They may extend to warping space with gravity effects of the new fusion.

### SUMMARY

The Hydrogen-Lithium Fusion Device (“HLFD”) is a revolutionary new device that includes a proton accelerator, lithium target, and a target support or holder, preferably of specified geometry. The HLFD enables a proton-lithium fusion efficiency that is expected to be close to 100% with the fusion byproducts exiting the lithium target without transferring significant fusion energy to the target as heat.

The Hydrogen-Lithium Fusion Device is expected to produce proton-lithium fusion at very high efficiencies. Hydrogen gas is supplied to an ion accelerator which creates a proton beam with the desired beam energy and current. The proton beam is aimed at a lithium target, typically a lithium foil target, supported by a target holder, the target holder preferably having specific physical characteristics. The incoming protons enter the lithium target and undergo continual small random direction changes until nuclear fusion occurs. The helium ion fusion byproducts undergo similar continual small random direction changes until they exit the target without transferring significant energy to the target as heat.

An example of a target assembly for use with a proton generator of the type capable of generating a proton beam along an axis, the proton beam having a transverse dimension at a target position, comprises a target support and a lithium target. The target support is locatable at the target position. The lithium target has front and back surfaces supported by the target support. The target has a maximum target thickness, measured generally parallel to the axis, less than the first zero of the J₀ Bessel function times the gravity wavelength of the proton. The target support is configured so that the target has exposed front and back target surfaces free of target support material. A projection of the exposed front surface onto the exposed back target surface defines the target area as an intersection between areas of the exposed front and back target area. In some examples the target support has a minimum thickness of at least 2.4 mm measured generally parallel to the axis, and more preferably has a minimum thickness of at least 3.14 mm measured generally parallel to the axis. In some examples the target has a minimum transverse dimension of at least 19.2 mm plus the transverse dimension of the proton beam.

An example of a method for making a target assembly for use with a proton generator of the type capable of generating a proton beam along an axis, the proton beam having a transverse dimension at a target position, is carried out as follows. A lithium target material having front and back surfaces is selected. The target material at the target area has a maximum target thickness, measured generally parallel to the axis, less than a the value of the first zero of the J₀ Bessel function times the gravity wavelength of the proton. A target support is chosen. The target material is mounted to the target support to create a target assembly locatable at the target position. The selecting, choosing and mounting steps are carried out so that the target assembly comprises a lithium target having exposed front and back target surfaces free of target support material. A projection of the exposed front surface onto the exposed back target surface defines the target area as an intersection between areas of the exposed front and back target area. In some examples the target support choosing step is carried out so that the target support has a minimum thickness of at least 2.4 mm, and more preferably at least 3.14 mm, measured generally parallel to the axis.

Particular aspects of the present invention are described in the claims, description and drawings.

### BRIEF DESCRIPTION OF THE DRAWINGS

FIG. 1 is a simplified view of an ion accelerator directing a proton beam at an exploded orthographic view of a target assembly;

FIG. 2 is an isometric view of the ion accelerator and target assembly of FIG. 1;

FIG. 3 is a simplified view of a six-way vacuum chamber;

FIGS. 4 and 5 are front and back views of the lithium target of FIG. 2 after a test procedure;

FIG. 6 is a simplified view of a target assembly showing the location of a proton beam and an exit ring on the target area;

FIG. 7 is a simplified cross-sectional view of the structure of FIG. 6;

FIG. 8 as a view similar to that of FIG. 7 in which the target support is in the form of a ring having a circular cross-sectional shape;

FIG. 9 shows a target support similar to that of FIG. 7 but in which the target material is secured to one side of the target support;

FIG. 10 is a simplified view of a further example of a target assembly in which the target material is supported by and spooled on and off of pickup and supply spindles;

FIGS. 11 and 12 are top and perspective views of a conducting element used in an Electrogravity Generator;

FIG. 13 is an array of conducting elements of FIGS. 11 and 12 surrounding a lithium target;

FIGS. 14 and 15 are top and perspective views of a Gravity Portal Device;

FIG. 16 illustrates an array of Gravity Portal Devices of FIGS. 14 and 15;

FIG. 17 is a top view of a gravity propulsion engine; and

FIG. 18 illustrates an array of Gravity Propulsion Engines of FIG. 17 within a vessel.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

This work stems from a fundamental unanswered question in physics. The question is where kinetic energy is stored. The classical and relativistic formulas for kinetic energy are well known. However, after searching the physics literature, the inventors could find no definitive answer as to where kinetic energy is actually stored; nor could the inventors answer a follow-up question: how does the storage of kinetic energy affect gravity? In addition to the literature search, the inventors talked to numerous physicists including a Nobel Prize winner. None could provide an answer to the kinetic energy storage question; the Nobel laureate said that this was a profound question to which he did not know the answer.

It is the inventors' belief that kinetic energy is stored in a field and that the storage of kinetic energy satisfies Einstein's mass-energy equivalence. As a result, the inventors looked for a mass density function that when integrated over the entire fabric of space would result in mass-energy equivalence. This process led to the development of the technical paper, “Gravity Theory Based on Mass-Energy Equivalence” and the disclosures herein. Subsequent to filing of the priority applications, the inventors' gravity theory published as, “Gravity Theory Based on Mass-Energy Equivalence” Acta Physica Polonica B 39, 2823 (2008) The inventors' gravity theory is reproduced at the end of this Detailed Description, starting at paragraph [0231] before the claims.

The Hydrogen-Lithium Fusion Device does not require additional containment beyond the vacuum chamber, nor does it initiate fusion through heat. Thus the problems of current hot fusion research programs are not present in the Hydrogen-Lithium Fusion Device.

In relation to the current fusion research programs, the Electrogravity Generator application described later has a very different implementation for achieving energy production. It is believed that the energy harnessed by the Electrogravity Generator is a one step process that transfers the kinetic energy released by proton-lithium fusion directly into DC electric power via electron vibration by gravity waves. The Gravity Portal and Gravity Propulsion Engine sections of this disclosure also described later are completely novel. To the inventors' knowledge, there are currently no other research projects or inventions which try to create and utilize gravity as a means for communication, transport, or propulsion.

### Concept of Hydrogen-Lithium Fusion Device

The reader should understand the sense in which “fabric of space” is used in this disclosure. Space is sometimes defined as a three-dimensional expanse in which all matter is located and all events take place, extending in all directions and variously described as extending indefinitely or as finite but immeasurably large. Many people think of space or outer space as emptiness between stars. Astrophysicists and others do not fully understand the composition of the space between stars. Some believe that particles and anti-particles are continuously created and annihilated in this space, which requires that there be more to space than emptiness. Reference in this disclosure to the fabric of space includes the energy or essence of space, beyond the nothingness that people think of as outer space.

The Hydrogen-Lithium Fusion Device presents a practical application of these inventors' gravity theory. In this theory, the rest mass and kinetic energy of an object separately distort the fabric of space according to mass-energy equivalence. Gravitational attraction between two objects results from the interaction of their mass density fields integrated over the entire fabric of space. The gravity experienced by each object is dependent on its own gravity wavelength.

The gravity theory predicts two types of gravity. Type I gravity reduces to classical gravity in the appropriate limits. It also includes a set of eight logarithmic singularities in the gravity force when the masses are equal or under special circumstances. Type II gravity is a new form of gravity. It includes an extremely strong wave gravity arising from a first-order singularity in the gravity potential that enables, for example, a moving helium ion to vibrate electrons or the units of the fabric of space. Type II gravity also enables a highly relativistic small object or units of the fabric of space to exert a very strong classical-type force on a large object.

The Hydrogen-Lithium Fusion Device creates the well-known hydrogen-lithium fusion reactions that release the indicated kinetic energies.

p+⁶Li→³He(2.3 MeV)+⁴He(1.7 MeV)

p+⁷Li→⁴He(8.6 MeV)+⁴He(8.6 MeV)

The HLFD uses well-known ion accelerator technology to create a beam of protons. The beam of protons then strikes a lithium target which is held by a target holder. The geometry of the lithium target and the target holder as derived from the gravity theory enables a high fusion efficiency that can be close to 100%, while enabling the fusion byproducts to exit the lithium target without transferring significant fusion energy to the target as heat.

In the sections that follow, this disclosure will present three further applications of the Hydrogen-Lithium Fusion Device: the Electrogravity Generator, the Gravity Portal, and the Gravity Propulsion Engine.

### Experimental Proof

The inventors conducted a set of experiments to provide experimental proof of the feasibility of the Hydrogen-Lithium Fusion Device. The experiments required a beam of protons, a lithium target, and a specially designed target holder. The equipment is summarized in the table below:

Equipment for Experimental Proof

### Facility

Space Environmental Effects Facility, Marshall Space Flight Center, Huntsville, Ala.

### Ion Accelerator

Pelletron series ion accelerator.
Proton beam from commercially available hydrogen gas.
Beam energy up to 400 keV.
Beam current between 10 and 40 μA.
Target area ending in a steel six-way cross vacuum chamber.

### Targets

99.9% pure commercially available lithium foils.
1.75×1.75 inches in area.
50, 100, and 250 microns thick.

### Target Holders

Two aluminum plates with circular center holes sandwich the lithium foil target.
Circular center hole has a diameter greater than the diameter of the proton beam.
Aluminum plates 1 and 5 mm thick.
5 mm thick aluminum plates have rounded or otherwise beveled edges.

### Protective Shielding

Steel six-way cross vacuum chamber provides protective shielding since fusion byproducts are helium ions (alpha particles).

During the periods Mar. 12 to Mar. 15, 2007 and Jun. 7 to Jun. 11, 2007, the inventors as well as other personnel from Unified Gravity Corporation (UGC) performed a series of hydrogen-lithium fusion experiments at NASA's Marshall Space Flight Center's Space Environmental Effects Facility in Huntsville, Ala. The facility was operated by personnel from Qualis Corporation, Huntsville, Ala.

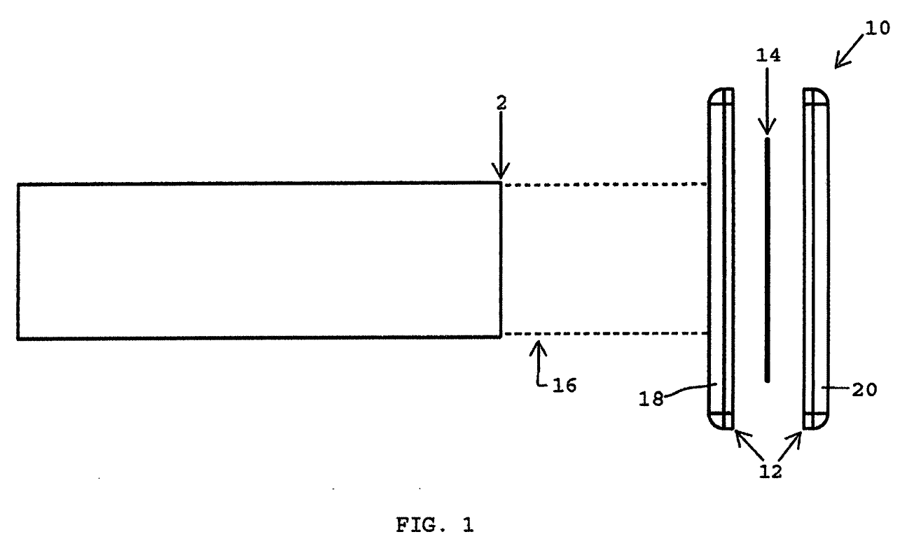

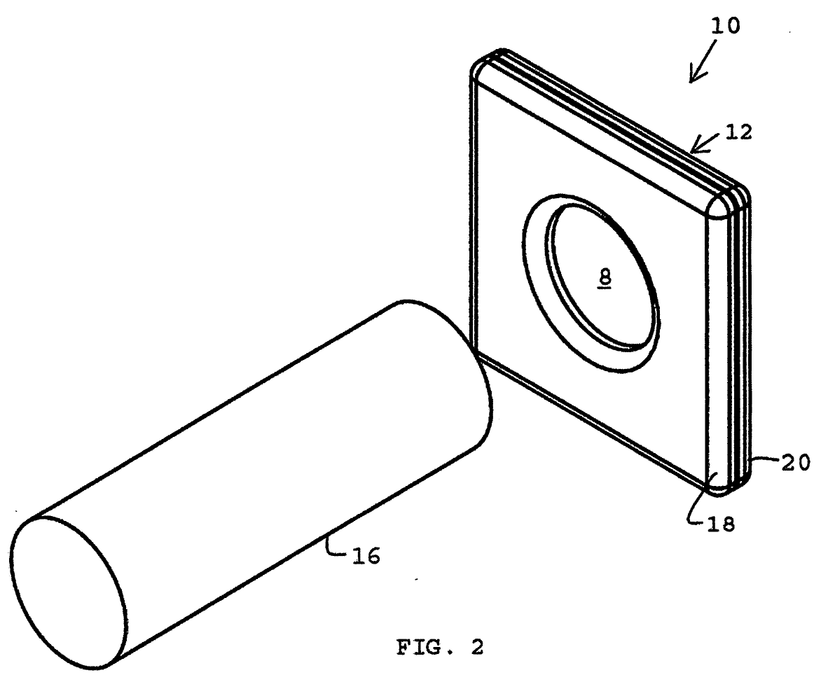

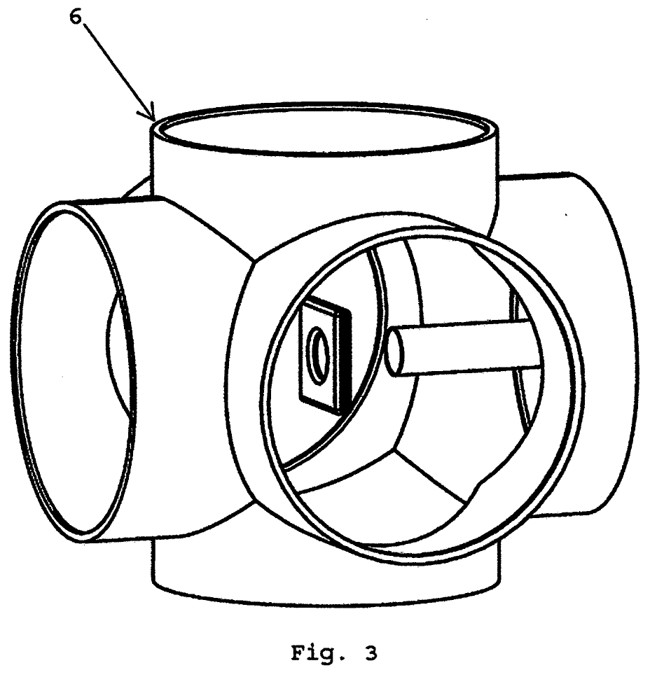

In the experiments, an ion accelerator 2, see FIGS. 1 and 2, using hydrogen gas as its ion source created a proton beam 16 with the 300 keV ion energy that was used to create proton-lithium fusion. The proton beam 16 was aimed at a target assembly 10 comprising a target support or target holder 12 supporting lithium target material 14, also recalled lithium foil 14 within a steel six-way cross vacuum chamber 6 as shown in FIG. 3.

Since the fusion byproducts of proton-lithium fusion are helium ions, no radiation shielding beyond the steel six-way cross vacuum chamber 6 was required.

The experiments explored the efficiency of the hydrogen-lithium fusion reaction as a function of the geometry of the lithium target 8 and the target holder 12.

The geometry of the lithium target 8 is important in that if the lithium target is a foil with no backing plate, an incoming proton experiences Type II gravity exerted by the lithium target nuclei in a ring on each side of the foil 14 approximately 2.4 mm from the proton. The Type II gravity results in continual small random momentum additions to the 300 keV proton's original momentum and enables the proton to sweep out a much larger area through the lithium foil than a single proton diameter. As a result, the probability that a proton will randomly walk into and initiate fusion with a lithium nucleus can be close to one.

The inventors predicted that the thickness of the lithium foil 14 should be less than 2.4 mm. If the thickness is greater than 2.4 mm, then the Type II gravity is only exerted by the lithium target nuclei in the 2.4 mm ring on the front side of the lithium target. This situation may reduce the proton energy below the threshold required for proton-lithium fusion, resulting in a proton transferring its energy into heat in the lithium target, and may lead to melting of the lithium target.

The geometry of the lithium target holder 12 is important in that if the incoming protons experience Type II gravity exerted by the target holder nuclei, the protons will experience large deflections as they approach the lithium nuclei. The deflection of the protons by the target holder nuclei then results in the transfer of proton energy into heat in the lithium target 8. Significant heat transfer by protons results in the melting of the lithium target 8.

If the thickness of the target holder 12 experienced by the proton is greater than π (3.14 . . . ) mm, the proton will not experience Type II gravity exerted by the target holder nuclei.

In the experiments, three lithium foil target thicknesses and two target holders were used. The experiments group into three distinct test categories that are summarized below.

PARAMETERS FOR EXPERIMENTAL TESTS

| | Lithium Target | Target Holder | Total Test | | Lithium Target |
|---|---|---|---|---|---|
| Test | Thickness | Plate Thickness | Duration | | Disposition |
| 1 | 50 microns | 1 mm | 1 | second | Melted |
| 2 | 100 microns | 5 mm | 35 | minutes | No damage |
| 3 | 250 microns | 5 mm | 2.6 | hours | No damage |

The smaller target holder 12, used for Test 1, consisted of two 7.6 cm×7.6 cm×1 mm aluminum plates each with a 3.8 cm diameter center hole. The larger target holder 12, used for Tests 2 and 3, consisted of two 7.6 cm×8.9 cm×5 mm aluminum plates each with a 3.2 cm diameter center hole. Edges of the larger target holder were rounded or otherwise beveled to remove all sharp corners.

The lithium target material 14 was foil 4.4 cm×4.4 cm square with thicknesses of 50, 100, and 250 microns. The lithium target material 14 was placed between the front and back members 18, 20 of the target holder 12.

In the first fusion test, the smaller target holder with a 1 mm plate thickness was used with a lithium target thickness of 50 microns. A proton beam 16 measuring 1 cm diameter and having 307 keV proton energy and 10, 15, and 20 μA beam currents was used for initial beam alignment. During this alignment protocol, the proton beam melted a large hole in the lithium target 8, destroying it.

Since 1 watt of power is delivered per 100 keV proton energy and per 10 μA beam current, the alignment protocol delivered 3, 4.5, and 6 watts of power into the lithium target 8. Since the melting point of lithium is 180 degrees C., the maximum temperature rise in the lithium can be only 160 degrees C. If all beam energy is delivered as heat to the lithium target 8, a beam diameter of 1 cm for the proton beam 16 results in a 150 degree C. temperature rise per second per watt of beam power delivered into the 1 cm beam cylinder. The corresponding heat diffusion rate from the 1 cm beam cylinder to the target holder 12 is 0.1 watts per 20 degree C. temperature rise in the beam cylinder 16, giving a maximum diffusion rate of 0.8 watts (0.1×160/20) from the beam cylinder 16 to the target holder 12. If a very low level of fusion occurs, the lithium target 8 melts in less than a second. This happens since even the lowest alignment power level of 3 watts will result in a potential 330 (2.2×150) degrees C. temperature rise per second in the portion of the lithium target 8 covered by proton beam 16 and extending the thickness of the target, sometimes called the beam cylinder.

These first test results are then consistent with the work of Herb who found very low levels of fusion taking place. Following Herb, one expects that a test generates heat instead of fusion and melts the target. Herb avoided melting the lithium in his target by using an extremely low beam current (10⁹ protons/second or 0.00016 uA) and a backing plate to dissipate heat from the target.

In our second fusion test, the larger target holder 12 with a 5 mm plate thickness was used with a lithium target material 14 having a thickness of 100 microns. A proton beam 16 measuring 1 cm diameter, having 307 keV proton energy and having 10, 15, and 20 μA beam currents, was used for initial beam alignment. During this alignment, the proton beam 16 did not damage the lithium target 8. The proton beam diameter was then increased to 2.5 cm and the beam current to 40 μA. The lithium target 8 was bombarded with protons for 35 minutes without damage.

For the 100 micron lithium target 8 used in the second fusion test, an alignment beam diameter of 1 cm was expected to produce a 75 degrees C. temperature rise per second per watt of beam power delivered into the beam cylinder. The corresponding heat diffusion rate from the 1 cm beam cylinder to the target holder 12 was calculated to be 0.3 watts per 20 degree C. temperature rise in the beam cylinder. Allowing a maximum 160 degree C. rise in temperature, the maximum heat diffused from the beam cylinder to the target holder 12 is 2.4 watts (0.3×160/20). Since the alignment protocol at 300 keV and 20 μA delivers 6 watts to the 1 cm beam cylinder, a maximum of 40% (2.4 watts/6 watts) of the beam power can be dissipated as heat. This means that 60% or more of the beam protons, based on these heat flow calculations, must undergo fusion or the target melts.

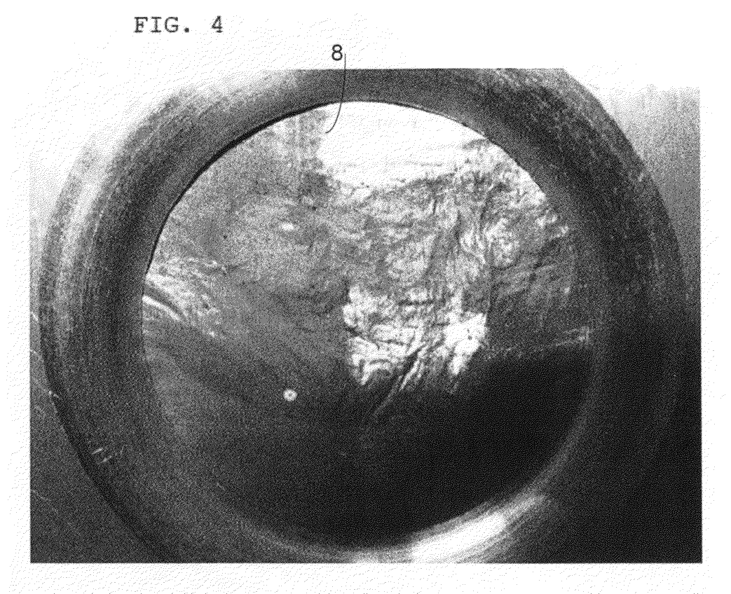

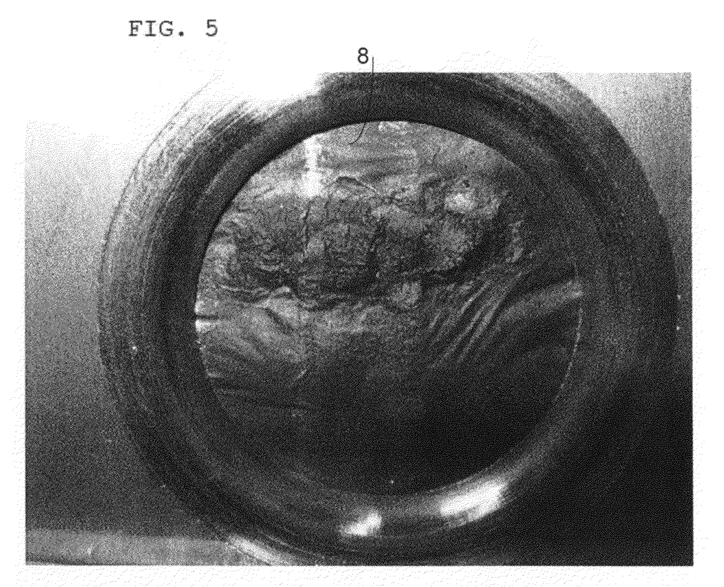

In our third fusion test, the larger target holder 12 with a 5 mm plate thickness was used with a lithium target 8 having a thickness of 250 microns. A proton beam 16 measuring 1 cm diameter and having 307 keV proton energy and 15 μA beam current was used for initial beam alignment. During this alignment, the proton beam 16 did not damage the lithium target 8. The proton beam diameter was then increased to 2.5 cm and the beam current to 36 μA. The lithium target was used for a total proton bombardment time of 2 hours and 35 minutes with some discoloration but without damage. The front and back of the 250 micron lithium foil used during the third test in the larger target holder before and after proton beam bombardment is shown in FIGS. 4 and 5 and illustrates the lack of damage to lithium target 8.

Since the thickness of the lithium target 8 in the third fusion test is 250 microns with the same target holder as in the second fusion test, the heat flow calculations do not require a larger efficiency than the 60% required by the second fusion test.

### Further Description of Target Assembly

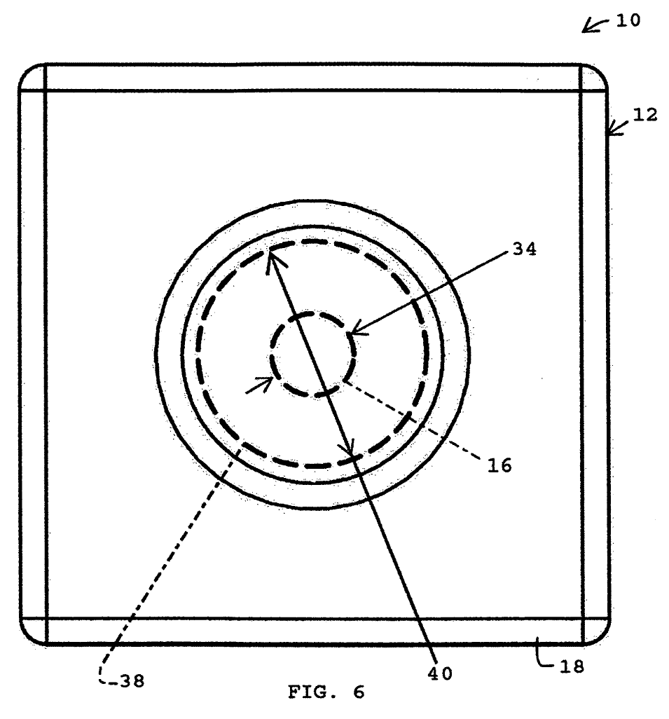

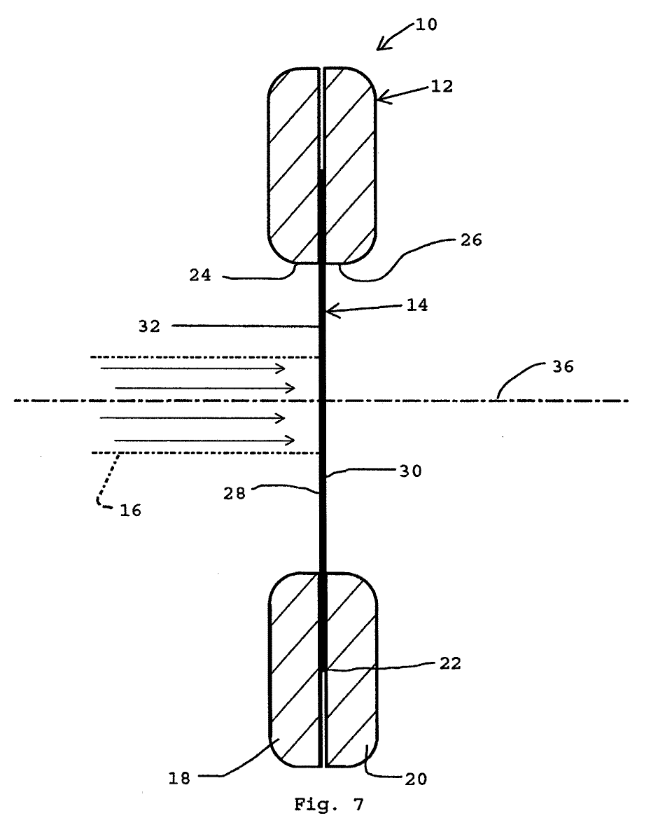

FIGS. 6 and 7, which are simplified, schematic illustrations of target assembly 10, are provided to help explain the construction parameters for the target assembly. Like elements may be referred to with like reference numerals. Target assembly 10 includes a target support 12 supporting lithium target material 14. Target support 12, in this example, includes front and back members 18, 20 which capture the peripheral edge 22 of target material 14 therebetween. Front and back members 18, 20 have aligned circular openings 24, 26 to create exposed front and back target surfaces 28, 30 and thus a target area 32 for proton beam 16 which is coextensive with front target surface 28. The edges of target support 12, especially the outer edges, are rounded or otherwise beveled with a radius of π (3.14 . . . ) mm for enhanced efficiency

Proton beam 16 has an average transverse dimension 34 centered on beam axis 36. Beam axis 36 is typically generally centered within target area 32 and is also generally perpendicular to target area 32. As discussed herein, protons impacting target area 32 undergo fusion and the resulting helium ions are influenced by lithium ions within 9.6 mm. Accordingly, exit of the helium ions is enhanced, and therefore it is preferred, that lithium target material 14 extends at least 9.6 mm from the periphery of proton beam 16. This creates what is called an exit ring 38 centered on axis 36. Exit ring 38 has a diameter 40 equal to transverse diameter 34 plus 2 times 9.6 mm. For example, assume a circular target area 32 having a diameter of 32 mm and a proton beam 16 having a diameter of 9.5 mm, exit ring diameter 40 would equal 28.7 mm. Therefore, so long as proton beam 16 is generally centered within target area 32, the entire exit ring 38 will lie on target area 32. Exit ring 38 can extend onto target support 12 so long as the exit ring lies on target material 14.

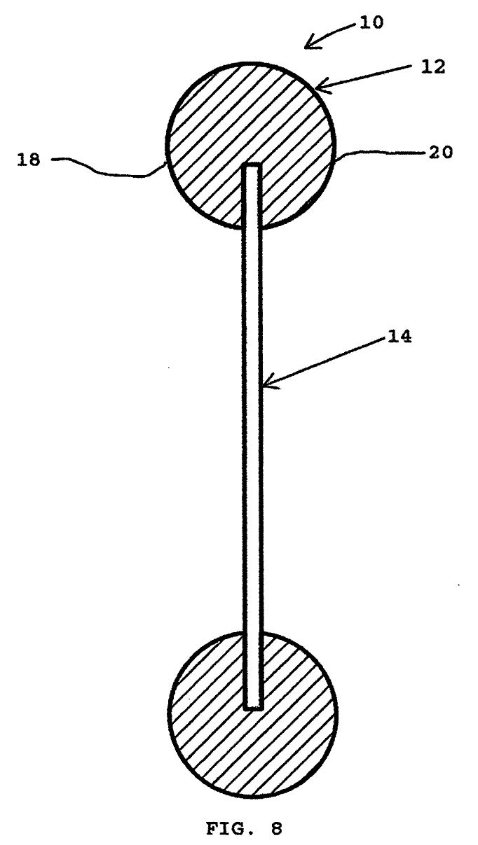

FIG. 8 illustrates an alternative example in which target support 12 comprises circular, ring-like front and back members 18, 20 instead of the rectangular front and back members 18, 20 of FIGS. 1 and 2.

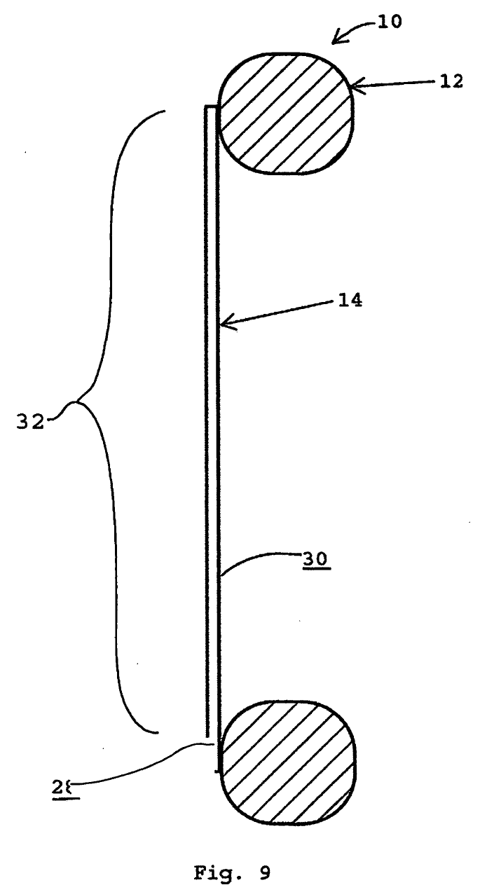

FIG. 9 shows another example of a target assembly 10 similar to that of FIGS. 6 and 7 but in which target material 14 is mounted to the front of target support 12. In this case exposed front target surface 28 is larger than exposed back target surface 30. The front and back target surfaces 28, 30 define an intersection, the intersection defining target area 32 along front target surface 28. Accordingly, it is the projected intersection of exposed front and back target surfaces 28, 30 that define target area 32 in the manner of a Venn diagram.

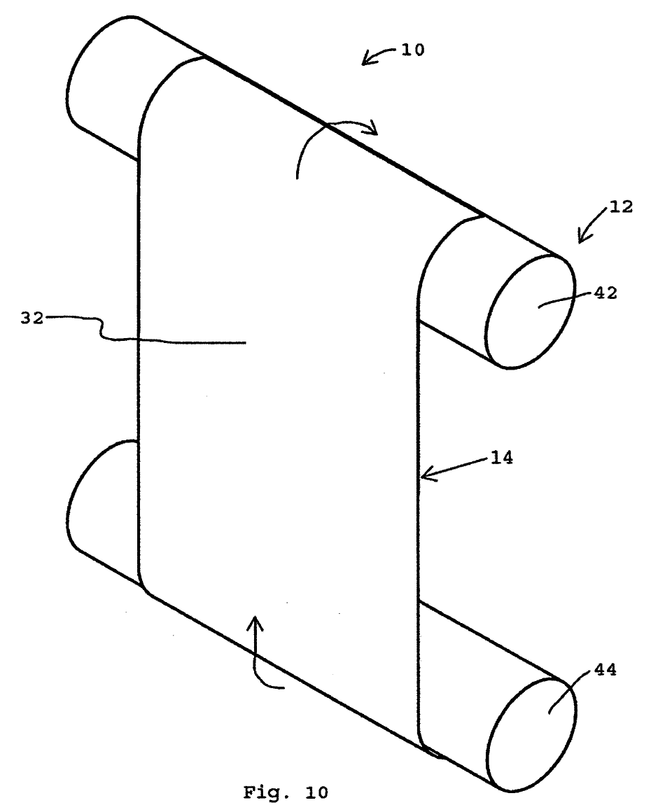

FIG. 10 shows a further example in which target support 12 does not circumscribe target area 32. Rather, target support 12 includes pickup and supply spindles 42, 44 on which target material 14 is wound. This type of target support 12 may be useful to permit new target material to be quickly and easily provided by simply unrolling new, unused target material 14 from supply spindle 44 and rolling used target material 14 onto pickup spindle 42. Additional target support structure may be used in conjunction with spindles 42, 44 to provide the necessary or desirable support for target material 14.

Other types of and configurations for target supports 12 can also be used. However, the primary requirement for all target supports is that they be configured to create exposed, generally aligned front and back target surfaces 28, 30 that are free of target support material.

As discussed elsewhere herein, the thickness of target material 14, measured generally parallel to axis 36, at target area 32 has been determined to be less than 2.4 mm. It is believed that it is important that the thickness of support 12, or at least that portion of support 12 adjacent to target area 32, be greater than 3.14 mm; the determination of this minimum thickness of support 12 is based upon the maximum distance between zeros of the J₀ Bessel function. However a smaller minimum thickness of less than 3.14 mm but at least 2.4 mm may be used with some reduction in efficiency, but in certain configurations may lead to melting of the lithium target. This smaller minimum thickness is based upon the minimum distance between zeros of the J₀ Bessel function.

### Discussion of Experimental Results

In general, each fusion reaction results in one of the two helium ions passing through the lithium target. The classical, predicted stopping distance of an 8.6 Mev helium ion in lithium is 180 microns. In the second fusion test in which the lithium target is 100 microns thick, conventional theory predicts that about ½ ( 100/180) of the fusion energy (or ¼ of the total fusion energy) will be transferred to the target as heat. If this happened, the lithium target would melt in less than a second since ¼ of the total fusion energy of a 300 keV 40 μA beam at 0.6 fusion efficiency is 100 watts and results in a 270 degrees C. temperature rise per second. In the third fusion test in which the lithium target is 250 microns thick, conventional theory predicts that about ½ of the total fusion energy will be transferred to the target as heat. Again, the lithium target would melt in less than a second since ½ of the total fusion energy of a 300 keV 36 μA beam at 0.6 fusion efficiency is 200 watts and results in a 220 degrees C. temperature rise per second.

According to conventional theory, the lithium target will melt either because the proton energy is transferred to the lithium foil as heat since the fusion efficiency is small or because the helium ion fusion byproduct energy is transferred to the lithium foil as heat if the fusion efficiency is large.

The longevity of the lithium target at such a high proton beam current provides experimental evidence for the feasibility of the Hydrogen-Lithium Fusion Device.

### Further Experimental Verification

An additional experimental test (#4) was performed in October, 2007 to provide positive evidence of the production of helium ions by the HLFD prototype. The method was to capture helium ions emitted by the HLFD in a shielded Faraday Cup and measure the helium ion DC current in the Faraday Cup.

The inventors constructed a shielded aluminum Faraday Cup in which the thicknesses of all aluminum, ceramic, and Teflon components were greater than about 3.14 mm as dictated by the inventors' gravity theory to enable high fusion efficiency. The Faraday Cup had an inner length to diameter ratio of 5:1 due to size limitations of the vacuum chamber. The 5.1 cm inner diameter of the Faraday Cup was larger than the 3.2 cm diameter of the exposed lithium target and was dictated by the desire to capture ½ of the helium ions expelled in a spherically symmetric manner resulting from the 2.5 cm diameter proton beam impinging the lithium foil target.

The Faraday Cup was positioned horizontally behind the HLFD by an aluminum frame constructed of bars whose thicknesses also exceeded about 3.14 mm. The Faraday Cup was placed directly behind the HLFD and in close proximity to the lithium foil so that the lithium foil and target holder blocked any protons in the proton beam from entering the Faraday Cup.

The inner collection cylinder of the Faraday Cup was connected to an electrical feed-through connector in a vacuum chamber flange and then to ground through an ammeter located next to the six-way cross vacuum chamber. The outer shield cylinder was directly grounded to the exterior of the six-way cross vacuum chamber.

The display of the ammeter during the test was recorded by a video camera. The test used a proton beam with a 330 keV proton energy and 32 μA beam current striking the HLFD's 250 micron thick lithium foil target. The October 2007 testing parameters and results are summarized below.

PARAMETERS AND RESULTS FOR OCTOBER 2007
EXPERIMENTAL TEST

| | | Target | | | |
|---|---|---|---|---|---|
| | Lithium | Holder | | | |
| | Target | Plate | Total Test | Faraday | Lithium Target |
| Test | Thickness | Thickness | Duration | Current | Disposition |
| #4 | 250 microns | 5 mm | 10.3 | 9.9 μA | Discolored, |
| | | | minutes | | intact |

A Residual Gas Analyzer (RGA) was used to measure the relative amounts of helium in the vacuum chamber when the proton beam was not incident on the foil compared to when the proton beam was impinging the foil.

### Discussion of Experimental Results

The capture of the helium ion fusion byproducts in the Faraday Cup is hypothesized to produce a measurable DC current. If the proton-lithium fusion reaction is 100% efficient, a proton beam current of 32 μA produces a 128 μA helium ion current (32 μA×2 helium ions×2 helium charges/1 proton charge). Assuming the helium ions are expelled in a spherically symmetric distribution, the maximum current in the Faraday Cup at 100% collection efficiency is 64 μA (128 μA×0.5 coverage). The DC current obtained in the Faraday Cup from the recorded data as a function of elapsed time is shown in FIG. 1.

There are several results to be noted in FIG. 1. The current dropped to zero at an elapsed time of 294 seconds when the beam was blocked by an upstream Faraday Cup to refocus the proton beam. Thereafter, the current rose as the proton beam was incident on the center of the target. The current reached a plateau at an elapsed time of 448 seconds once the proton beam was centered on the foil.

The maximum current recorded by the ammeter connected to the Faraday Cup was 11.6 μA, see FIG. 2, and the average current at the plateau was 9.9 μA. This average current results in a lower bound of approximately 15.5% (9.9 μA/64 μA) for the proton-lithium fusion efficiency. We hypothesize that the large 5.1 cm inner diameter of the Faraday Cup decreased its collection efficiency.

In addition to the DC current measured by the Faraday Cup, fusion was also indicated by a fivefold rise in helium levels within the vacuum chamber as recorded by the RGA. It is unclear how the interaction of helium ions with the vacuum chamber walls affects the concentration of helium in the vacuum chamber, so the RGA data was used only as an indicator that fusion was occurring.

When the test was completed and the Faraday Cup removed from the ion accelerator, it was hot to the touch, confirming the transfer of fusion energy into heat.

The total time of proton bombardment during test #4 was 10 minutes and 20 seconds. The lithium target in the HLFD showed signs of discoloration due to proton bombardment, but remained intact (FIG. 3) as in tests #2 and #3. For that reason, as discussed in international patent application # PCT/US07/018256, heat flow calculations indicate that proton-lithium fusion efficiency exceeds 60%.

Therefore the results of experimental test #4 as well as tests #2 and #3 provide evidence that the proton-lithium fusion efficiency using the inventors' HLFD is far greater than the experiments of Herb and others have indicated. These experimental results then provide proof of the feasibility of the HLFD and lend support to the inventors' gravity theory based on mass-energy equivalence.

In addition, the results of experimental test #4 provide proof of the feasibility of the Fusion Heat Engine. The capture of each helium ion fusion byproduct by the Faraday Cup transfers fusion kinetic energy into heat in the Faraday Cup. Using the lower bound of 15.5% for the fusion efficiency, a proton beam current of 32 μA (32*6.2 10¹² protons/sec), and an average fusion event energy of 16.2 MeV, the fusion kinetic energy transferred into heat exceeded 5.0 10¹⁴ MeV/sec (0.155*32*6.2 10¹²*16.2)=80 joules/sec=80 watts. Since the experimental results demonstrate that the proton-lithium fusion efficiency can be close to 100% and that the fusion energy can be transferred into heat, the Fusion Heat Engine device described below can achieve and surpass the break-even point of energy production.

### Additional Experimental Verification

In April 2008 under a Space Act Agreement with NASA, UGC performed 4 additional experimental tests referred to as tests #5-8. In test #5, the Faraday Cup used in test #4 and subsequently in test #8 was calibrated. In tests #6-7, control experiments were performed that included components used in the previous tests #1-4. In test #8, the Faraday Cup was used to measure both current and heat from fusion byproducts.

Tests #5-8 provide additional experimental proof of the feasibility of the Hydrogen-Lithium Fusion Device (HFLD) and its applications. The facility, ion accelerator, targets, target holders and protective shielding were substantially as described above, except that the beam energy and current were increased in some runs to 700 keV and 42 μA. In addition, the following measurement apparatus were used:

### Faraday Cup

10.2 cm diameter aluminum cylinder as outer shield, 1.3 cm sidewalls, 26.7 cm long with beveled edges
6.4 cm diameter aluminum cylinder as inner collector, 0.64 cm sidewalls, 25.4 cm long with beveled edges
Ceramic bars to isolate the inner cylinder from the outer cylinder
Outer cylinder grounded
Inner cylinder connected to ground through an ammeter

### Measurement Devices

Fluke Ammeter
Fluke Infrared Thermometer

In tests #5-8, an ion accelerator using hydrogen gas as its ion source created a proton beam with an energy between 300 and 700 keV in order to produce proton-lithium fusion. In test #5, the proton beam was directed into the Faraday Cup used in test #4 but without any target. In test #6, the target was a lithium foil contained between two 1 mm thick aluminum plates and was similar in dimensions to the target used by Herb. In tests #7-8, the target conformed to the requirements specified for a Hydrogen-Lithium Fusion Device (HFLD).

When used, the Faraday Cup was placed horizontally directly behind and close to the lithium foil and target holder, which completely shielded the inner cylinder of the Faraday Cup from the proton beam. The inner cylinder was connected to a BNC electrical feed through connector in the side flange of the six-way cross vacuum chamber and then to an ammeter and to ground. The outer shield cylinder of the Faraday Cup was also connected to a BNC electrical feed through connector and then directly to ground. The ammeter display was recorded with a digital video camera during the entire test.

Since the byproducts of hydrogen-lithium fusion are helium ions, no radiation shielding beyond the six-way cross vacuum chamber was used.

Test #5 involved the calibration of the UGC Faraday Cup as compared to the National Electrostatics Corporation (NEC) Faraday Cup which is used to measure the proton beam current inside the Pelletron ion accelerator. The UGC Faraday Cup that was used in the previous test #4 was placed horizontally within the vacuum chamber such that the proton beam impinged on the back of the UGC Faraday Cup since there was no lithium target or holder. An aluminum frame constructed of bars whose thicknesses exceeded about 3.14 mm supported the UGC Faraday Cup.

The UGC Faraday Cup current reading was taken with the same ammeter used in the control room to view the proton beam current of the Pelletron ion accelerator. When the upstream NEC Faraday Cup was moved from the path of the proton beam, the readings on the meter switched from the upstream NEC Faraday Cup to the UGC Faraday Cup.

Test #5 was performed in three steps with the proton beam energy set to 310 keV for all steps. The first step used a 1 cm diameter proton beam with an 11.8 μA current as detected by the upstream NEC Faraday Cup. The UGC Faraday Cup indicated a proton beam current of 11.8 μA. The second step used a 2.5 cm diameter proton beam with a 21.1 μA current as detected by the upstream NEC Faraday Cup. The UGC Faraday Cup indicated a proton beam current of 21.1 μA. The third step used a 2.5 cm diameter proton beam with a 30.1 μA current as detected by the upstream NEC Faraday Cup. In this case, the UGC Faraday Cup indicated a proton beam current of 30.3 μA.

The results of the UGC Faraday Cup calibration test show that the UGC Faraday Cup is 100% efficient. The difference in step three of test #5 can be attributed to the proton beam not being completely centered on the smaller upstream NEC Faraday Cup at high current.

Test #6 was a control experiment for test #3 and used a 250 micron thick lithium foil in a thin target holder similar to the one used by Herb. Test #3 also used a 250 micron thick lithium foil, but in a target holder conforming to the HLFD requirements. To produce an exact control of test #3, copper conducting elements with ceramic holders were placed in four flanges of the vacuum chamber as to comply with a secondary experiment that was performed in conjunction with test #3. The beam alignment protocol used for test #3 was used in test #6 with the proton beam energy set to 307 keV.

The first impingement used a 1 cm proton beam diameter and a 10 μA proton beam current and lasted for 1 minute. A visual inspection then revealed that the proton beam left a visible discoloration on the lithium foil but the lithium foil did not blister. The second impingement used a 1 cm diameter proton beam and a 15 μA proton beam current and also lasted for 1 minute. A second visual inspection then revealed that the lithium foil had visible blistering. The third impingement used a 1 cm diameter proton beam and a 20 μA proton beam current and lasted for 10 minutes. A third visual inspection then revealed that the lithium foil had increased visible blistering, but was intact.

The proton beam diameter was then increased to 2.5 cm and the proton beam current to 26 μA for a period of 41 minutes. A visual inspection then revealed that the lithium foil was blistered but intact.

If no fusion occurs, heat flow calculations indicate that for a 250 micron thick target with a 1 cm proton beam diameter, the lithium foil target melts if the proton beam current exceeds 25 μA. To test that little or no fusion was occurring, the proton beam diameter was decreased to 1 cm while the proton beam current remained at 26 μA. After a period of 5 minutes, a visual inspection revealed that the target indeed had a large hole melted through the area where the proton beam impinged the lithium foil. These results are also consistent with results of test #1 which also used a thin target holder and the low fusion efficiency values obtained by Herb that indicate the lithium target melts as a result of proton heating. FIG. 1 shows the remains of the lithium foil after completion of test #6.

Test #7 was as a control experiment for test #1 in which the 50 micron lithium foil melted in less than a second during the beam alignment protocol. As opposed to the thin target holder used in test #1, test #7 used a 50 micron lithium foil in the HLFD that was used in the 2007 experiments. To comply with the conditions of test #1, copper conducting elements supported by ceramic frames were placed in the four horizontal flanges.

As in test #1, the proton beam diameter was set to 1 cm, the proton beam energy to 307 keV, and the proton beam current to 10 μA. The proton beam impinged the lithium foil for 5 minutes without any sign of a hole or melting. FIG. 2 was taken after this first beam impingement and shows no visible damage.

The proton beam diameter was then increased to 2.5 cm and the proton beam current to 29 μA. The proton beam impinged the foil for 11 minutes. The lithium foil was found to only be discolored with no indication of a hole or tear. FIG. 3 shows the experimental setup inside the vacuum chamber.

The proton beam energy was then increased to 330 keV while the proton beam current remained at 29 μA. The beam impinged the foil for another 5 minutes. After completion of experimental test #7, the 50 micron lithium foil was extracted from the vacuum chamber and was found to have no holes. FIG. 4 is a picture of the foil immediately after being removed from the vacuum chamber.

Test #8 was a reproduction of test #4 and was performed using the HLFD, a 250 micron lithium foil, and the UGC Faraday Cup. The method was to capture helium ions emitted by proton-lithium fusion in the Faraday Cup and measure the DC current resulting from the helium ions collected in the Faraday Cup. The proton beam energy was set to 700 keV and the proton beam current to 20 μA. The proton beam current averaged 21.4 μA and the proton impingement time was 91 minutes.

If the proton-lithium fusion reaction is 100% efficient, a proton beam current of 21.4 μA produces a 85.6 μA helium ion current (21.4 μA×2 helium ions×2 positive charges/1 proton charge). Assuming the helium ions are expelled in a spherically symmetric distribution, the maximum helium ion current in the UGC Faraday Cup at 100% collection efficiency is 42.8 μA (85.6 μA×0.5 coverage).

During all tests performed with the UGC Faraday Cup measuring helium ions created by proton-lithium fusion, the DC current detected by the ammeter was in fact always negative. This negative Faraday current can be explained by the dynamics of the fusion reaction.

When a proton fuses with a lithium nucleus, the result is the temporary creation of a beryllium ion. The increased charge of the beryllium ion is sufficient to capture an additional electron present in the conduction band of the lithium target. The beryllium nucleus then splits into two energetic helium ions that travel in opposite directions and leaves a total of four free electrons with forward momentum as imparted by the former beryllium nucleus. The momentum imparted to the electrons enables the electrons to randomly walk through the lithium foil in the same way as the helium ions and be collected in the Faraday Cup.

With half of the helium ions each having a double positive charge and four electrons with a quadruple negative charge collected in the Faraday Cup, a negative current double the proton beam current should be detected when 100% fusion efficiency is achieved. This was the case during test #8 in which a negative current close to double the proton current was measured but never exceeded.

The Faraday Cup during test #8 detected a measurable DC current in the high −μA range throughout the entire 91 minute period of proton impingement with two negative current plateaus that were close to double the proton current. The graph of the Faraday Cup current versus elapsed time is shown in FIG. 5.

The maximum current in the Faraday Cup was −42.1 μA as documented in FIG. 6, and the average Faraday current was −24.4 μA. This average current indicates an average proton-lithium fusion efficiency of 57% (24.4 μA/42.8 μA). FIG. 7 shows that the lithium foil target remained intact after the completion of test #8.

There are several results to be noted in FIG. 5. The first plateau occurred at an elapsed time of 15 minutes reaching a Faraday current of −42.1 μA with a proton beam current of 21.6 μA. This reading indicates 97% fusion efficiency. Thereafter, the Faraday current dropped while the proton beam was still impinging the target. The Faraday current dipped to −16 μA but then steadily climbed during the remainder of the test. The Faraday current increased to −40 μA at 86 minutes and to −40.2 μA at 89 minutes, indicating fusion efficiencies of 99% and 99.5% as the proton beam current was 20.1 μA. The parameters and results of tests #6-8 are summarized in the following table.

PARAMETERS AND RESULTS FOR APRIL
2008 EXPERIMENTAL TESTS

| | Lithium Target | | Total Test | Lithium Target |
|---|---|---|---|---|
| Test | Thickness | Target Holder | Duration | Disposition |
| #6 | 250 microns | Thin | 58 minutes | Melted |
| | | Holder <2.4 mm | | |
| #7 | 50 microns | HLFD | 21 minutes | No damage |
| #8 | 250 microns | HLFD | 91 minutes | Slight crack |

The temperature of the inner cylinder of the Faraday Cup was also recorded after the vacuum chamber was opened. Using a Fluke IR thermometer, the temperature of the Faraday Cup after test #8 was found to be 90° C. resulting in a temperature change ΔT=70° C.

For a 24.4 μA average current in the Faraday Cup, the heat energy transferred by the helium ions to the aluminum inner cylinder is 98.7 watts. With an inner cylinder mass of 886.6 gm, the expected temperature change after 91 minutes is calculated to be 675 degrees C. compared to the measured 70 degrees C. We suggest that the heat loss occurred through an electrically insulating Teflon disk, three Macor ceramic bars used to separate the cylinders, and a single steel screw insulated with Kapton tape between the inner and outer aluminum cylinders of the Faraday Cup. The heat energy was then transferred from the outer cylinder through the large aluminum Faraday Cup support to the vacuum chamber housing.

The properties of the four electrically insulating objects within the Faraday Cup are as follows. The PTFE Teflon disk had a 6.35 cm diameter contact area and 0.635 cm thickness with a thermal conductivity of 0.003 W/cm·K. The three Macor ceramic bars between the inner and outer cylinders were each 2.54 cm×0.635 cm×0.635 cm with a thermal conductivity of 0.014 W/cm·K. The steel screw had a 0.325 cm diameter shaft with 0.325 cm depth thread contact area with a thermal conductivity of 0.26 W/cm·K, and the strip of electrically insulating Kapton tape over the screw and the exposed current wire had a contact area of 0.63 cm2 and a thickness of 0.005 cm with a thermal conductivity of 0.0046 W/cm·K. As a result, the heat energy transfer from the inner to outer cylinder is calculated to be dQ/dt=0.96*ΔT watts.

Using a heat energy transfer of 98.7 watts from the helium ions to the inner cylinder and a 0.96 [watts/degree C] value for heat energy transfer from the inner to outer cylinder of the Faraday Cup, FIG. 8 shows the calculated temperature change ΔT in the inner Faraday Cup as a function of elapsed time. The confirmation of the 70 degrees C. temperature change about 5 minutes after the completion of the test #8 lends support to high fusion efficiency and heat energy transfer from the helium ion fusion byproducts to the inner cylinder of the Faraday Cup.

### Some Inconclusive Experiments

During experiments in September 2008, several tests yielded inconclusive results. These tests were performed under a Space Act Agreement with NASA. The goal of these tests was to produce additional successful results similar to those in April 2008. The primary equipment of the tests involved the HLFD and the UGC designed Faraday Cup. As in previous tests, the Faraday Cup was used to measure both a DC current and heat from the fusion byproducts created in the HLFD.

Result Summary of Inconclusive Tests

In all experimental tests that were performed with the UGC Faraday Cup in September 2008, a Faraday cup current in the low −nA range was indicated at the start of each test, then after about an hour of proton impingement the current would rapidly rise to the −μA range. Shortly after reaching the −μA range, an area on the lithium target began to illuminate with an intense white and quickly changed to a black spot. After each instance where an illuminated spot developed on the target, the target was visually examined and in all cases was found to have a hole. This behavior occurred in a similar location on all lithium targets used in September 2008.

Upon completion of the September 2008 test series, the interior components of the UGC Faraday Cup were examined. Examination showed that a Teflon spacer, used to isolate the inner cylinder from the outer shield cylinder, rotated 45 degrees from its original position and resulted in an exposed edge to the HLFD.

Hypothesis for Reduction of Efficiency in Fusion Initiation and Byproduct Exit

The inconclusive tests are believed to be explained by two main factors that were not anticipated by the UGC personnel and that caused the reduction in both fusion efficiency and helium ion exit efficiency.

The first factor was contamination of the lithium target surface area by oxygen and nitrogen from the laboratory atmosphere during its removal from the argon environment of the shipping container. The build up of an oxygen and nitrogen overburden created a very thin front and back plate composed of oxygen and nitrogen. The HLFD patent application predicts that an overburden layer can reduce fusion efficiency to Herb's level. The −nA Faraday cup current indicated that low levels of fusion occurred during September 2008. However, after approximately an hour of proton impingement, the current rapidly rose into the −μA range shortly before an illuminated spot would appear. This behavior of the Faraday cup current indicated that the proton beam slowly removed the overburden, which then allowed for fusion efficiency to increase to a high level.

The second factor was created by geometry of an exposed edge, which suggests edge effects play a significant role in efficiency of fusion initiation and byproduct exit from the HLFD. When an increase in fusion occurred, the ammeter rose into the −μA range shortly before the lithium developed a hole. The exposed edge of the Teflon spacer reduced the exit efficiency of the helium ions and resulted in heat transfer to the lithium target. The location of the hole in the lithium targets corresponded to the exposed edge from the Teflon spacer inside the Faraday Cup.

### General Discussion of Hydrogen-Lithium Fusion Production

A proton beam derived from hydrogen gas is accelerated though well-known methods to create proton-lithium fusion. The beam of protons can be produced by an ion accelerator, ion implanter, Van de Graff accelerator, RF Quadruple accelerator, or other such device. The term ion accelerator is used as a generic term for any device that accelerates ions by any method.

The accelerated protons are aimed at a lithium target. The term lithium target is used subsequently as a generic term for a target of a specific shape, dimension, or composition that contains lithium. For example, the target can be metallic lithium, lithium oxide, or a lithium alloy. The lithium target should be a lithium foil whose thickness should be less than 2.4 mm.

The lithium target can be replenished by well-known methods. For example, a spool of lithium or lithium alloy strip can be cycled through the target holder; see, for example, FIG. 10. Another method of fuel replenishment is to turn off the device and replace lithium targets.

The target holder typically includes two plates with center holes that sandwich the lithium foil target. The thickness of each plate should exceed π (3.14 . . . ) mm and the edges of each plate should be rounded or otherwise beveled to remove sharp corners. The thickness of the target holder plates as well as the beveled edges allow the incoming protons and exiting helium ions to experience only Type II gravity exerted by the lithium target nuclei and not the target holder nuclei. The target holder can be aluminum, nickel, or any other material that can be used in a vacuum chamber and preferably conduct heat away from the lithium target.

As the protons approach the lithium target, the proton experiences Type II gravity exerted by lithium nuclei in a ring of each side of the lithium foil approximately 2.4 mm from the proton. The Type II gravity causes the proton to experience continual random momentum additions in the direction of the lithium nuclei. As a result, the probability that a proton will randomly walk into and initiate fusion with a lithium nucleus can be close to one.

A proton-lithium fusion event results in the production of two high energy helium ions. Similar to the movement of the protons in the lithium target, the helium ions also experience the continual random momentum additions from the Type II gravity exerted by the lithium nuclei, but in a ring on each side of the lithium foil approximately 9.6 mm from the helium ion. As a result, the probability that a helium ion will randomly walk out of the lithium foil can be close to one and the helium ion will exit the lithium target without transferring heat to the lithium target.

The resulting helium ions can be utilized as a power source for applications such as an electrogravity generator, gravity portal, or gravity propulsion engine.

After transferring their kinetic energy, the helium ions can be collected by well-known methods such as vacuum pump.

### Application of Gravity Theory to the Hydrogen-Lithium Fusion Device

The Hydrogen-Lithium Fusion Device is predicated on a gravity theory described in a technical paper by the inventors Stephen A. Lipinski and Dr. Hubert M. Lipinski, Unified Gravity Corporation, Gravity Theory Based on Mass-Energy Equivalence, June 2007 and September 2008, much of which was submitted with provisional applications and the PCT application. This paper can be found below, preceding the claims.

According to the gravity theory based on mass-energy equivalence, the Type II gravity potential V_{G} exerted by an object A on an equal or smaller size object B (e.g. a lithium nucleus on a proton, a lithium nucleus on a helium ion, a helium ion on an electron, or a helium ion on an unit of the fabric of space) is given by:

V_{G}(r_{B})=−Gm_{A}m_{B}λ_{A}/λ_{B}J₀(r_{B}/λ_{B})/r_{B}(1−v_{A}²/c²)(1−v_{B}²/c²)^{1/2}1/π(1/ε|_{ε=0}),

where r_{B} is the distance of object A from object B, G is the gravitational constant, m_{A} is the rest mass of object A, m_{B} is the rest mass of object B, λ_{A} is the gravity wavelength of object A, λ_{B} is the gravity wavelength of object B, J₀ is the 0^{th} order Bessel function of the first kind, v_{A} is the speed of object A, V_{B} is the speed of object B, c is the speed of light, and (1/ε|_{ε=0}) is a first-order singularity.

The gravity wavelength λ_{G} of an object is given by λ_{G}=N_{AG}M where N_{AG}≈6.0×10²³ m/kg and M is its rest mass. For example, a helium ion has a gravity wavelength≈4 mm, a proton has a gravity wavelength≈1 mm, an electron has a gravity wavelength≈0.55 microns, and a unit of the fabric of space has a gravity wavelength≈2 mm.

Since the Type II gravity potential has a first-order singularity, the Type II gravity force experienced by object B is zero for distances less than its gravity wavelength. For distances greater than its gravity wavelength, a very large gravity force F_{G} occurs whenever J₀(r_{B}/λ_{B}) changes sign:

F_{G}(r_{B})=Gm_{A}²/λ_{B}J₁(r_{B}/λ_{B})/r_{B}(1−v_{A}²/c²)^{-1/2}(1−v_{B}²/c²)^{1/2}1/π(1/ε|_{ε=0}),

where J₁ is the 1^{st} order Bessel function of the first kind and r_{B}/λ_{B} is a zero of the J₀ Bessel function. For example, the first zero of the J₀ Bessel function occurs at a value of r_{B}/λ_{B}≈2.4.

Since a force results in a change in momentum, the Type II gravity force imparts a momentum addition to object B in the direction of the Type II gravity force as object B moves through the zeros of the J₀ Bessel function.

Hydrogen gas and lithium are the preferred fuels for the Hydrogen-Lithium Fusion Device. The hydrogen gas is delivered to an ion accelerator 2 FIG. 1 that is aimed at a lithium target 14. The creation of a beam of ions, that is proton beam 16, is a well-known process and can be achieved with an ion accelerator, ion implanter, Van de Graff accelerator, RF Quadruple accelerator, or other such device.

As an incoming proton nears and then enters the lithium foil of the target, it experiences a Type II gravity force from each lithium nucleus on the side of the target at a distance≈2.4 mm (2.4×1 mm) corresponding to the first zero of the Bessel function. If the distance to the side is greater than 2.4 mm, then the Type II gravity potential will include both positive and negative values, and no Type II gravity force will occur.

As a result, the proton receives momentum additions from each lithium nucleus in a ring approximately 2.4 mm from the proton on both sides of the lithium foil. Since the lithium nuclei occur at random locations in both 2.4 mm rings, the continual small random momentum additions to the 300 keV proton's original momentum enable the proton to sweep out a much larger area through the lithium foil than a single proton diameter. As a result, the probability that a proton will randomly walk into and initiate fusion with a lithium nucleus can be predicted as close to one.

Type II gravity also enables helium ions to exit the lithium target without transferring heat energy to the target. As the helium ion traverses the target, it experiences a Type II gravity force exerted by each lithium nucleus on either side of the lithium foil at a distance≈9.6 mm (2.4×4 mm) corresponding to the first zero of the Bessel function. If the distance to the side is greater than 9.6 mm, then the Type II gravity potential will include both positive and negative values, and no Type II gravity force will occur.

As a result, the helium ion receives a momentum addition from each lithium nucleus in a ring approximately 9.6 mm from the helium ion on both sides of the lithium foil. Since the lithium nuclei occur at random locations in both 9.6 mm rings, a helium ion will randomly walk out of the lithium target due to the continual small random momentum additions to the 8.6 Mev helium ion's original momentum.

The target holder 12 of the Hydrogen-Lithium Fusion Device does not affect an incoming proton if the Type II gravity potential exerted on the proton by the nuclei of the target holder that are in the same direction includes both positive and negative values.

This situation occurs if the thickness of the target holder in any direction as experienced by the proton is greater than the distance between two adjacent zeros of the J₀ Bessel function. The maximum distance between two adjacent zeros is π times the gravity wavelength since the J₀ Bessel function asymptotically approaches a cosine function. Hence the thickness of the target holder must be greater than approximately π mm (π×1 mm) in order to avoid exertion of a Type II gravity force by the target holder on the proton.

### Theoretical Basis for Geometric Requirements

The heat collection device conforms to a set of geometric requirements dictated by the gravity theory developed by the inventors, in order to preserve the high fusion efficiency that prevents the destruction of the HLFD's lithium target by heat.

According to the gravity theory based on mass-energy equivalence, the Type II gravity potential V_{G} exerted by an object A on an equal or smaller size object B (e.g. a lithium nucleus on a proton, an aluminum nucleus on a proton, a lithium nucleus on a helium ion, or a helium ion on an electron) is given by:

V_{G}(r_{B})=−Gm_{A}m_{B}λ_{A}/λ_{B}J₀(r_{B}/λ_{B})/r_{B}(1−v_{A}²/c²)^{-1/2}(1−v_{B}²/c²)^{1/2}1/π(1/ε|_{ε=0}),

where r_{B} is the distance of object A from object B, G is the gravitational constant, m_{A} is the rest mass of object A, m_{B} is the rest mass of object B, λ_{A} is the gravity wavelength of object A, λ_{B} is the gravity wavelength of object B, J₀ is the 0^{th} order Bessel function of the first kind, v_{A} is the speed of object A, v_{B} is the speed of object B, c is the speed of light, and (1/ε|_{ε=0}) is a first-order singularity.

The gravity wavelength λ_{G} of an object is given by λ_{G}=N_{AG}M where N_{AG}≈6.0 10²³ m/kg and M is its rest mass. For example, a lithium nucleus has a gravity wavelength≈7 mm, an aluminum nucleus has a gravity wavelength≈27 mm, a helium ion has a gravity wavelength≈4 mm, a proton has a gravity wavelength≈1 mm, and an electron has a gravity wavelength≈0.55 microns.

Since the Type II gravity potential has a first-order singularity, the Type II gravity force experienced by object B is zero for distances less than its gravity wavelength. For distances greater than its gravity wavelength, a very large gravity force F_{G} occurs whenever J₀(r_{B}/λ_{B}) changes sign:

F_{G}(r_{B})=Gm_{A}m_{B}λ_{A}/λ_{B}²J₁(r_{B}/λ_{B})/r_{B}(1−v_{A}²/c²)^{-1/2}(1−v_{B}²/c²)^{1/2}1/π(1/ε|_{ε=0}),

where J₁ is the 1^{st} order Bessel function of the first kind and r_{B}/λ_{B} is a zero of the J₀ Bessel function. The first zero of the J₀ Bessel function occurs at a value of about 2.4, while the maximum distance between adjacent zeros is π which is about 3.14 since the J₀ Bessel function asymptotically approaches a cosine function.

Since a force results in a change in momentum, the Type II gravity force imparts a momentum addition to object B in the direction of the Type II gravity force as object B moves through the zeros of the J₀ Bessel function.

If the Type II gravity potential exerted on the proton in the lithium target by the nuclei of the heat collection device that are in the same direction includes both positive and negative first-order singularity values, the Type II gravity force exerted by the nuclei on the proton is zero. This same consideration applies to the nuclei of the target holder in the HLFD.

To allow the incoming protons to experience only Type II wave gravity exerted by the lithium target nuclei and not by the heat collection device nuclei, the thickness of the walls, components, and support structures of the heat collection device as experienced by an incoming proton in the beam cylinder of the lithium target should exceed about 2.4 mm (2.4×1 mm) or about 3.14 mm (π×1 mm), depending on the distance between protons at the target and the nuclei of the heat collection device. Counter-intuitively (if intuition applies in this realm), we predict that a smaller thickness is sufficient in close proximity and a large thickness is required at a greater distance. Prudent design can b satisfied by choosing the greater thickness. These two thickness values are determined by the minimum and maximum distances between adjacent zeros of the J₀ Bessel function multiplied by the proton gravity wavelength.

In experimental test #1, the lithium foil target with a target holder consisting of two 1 mm plates and thus not conforming to the geometric requirements melted within a second.

### Electrogravity Generator Application

### Concept of Electrogravity Generator

The Electrogravity Generator is a device that is predicted to convert hydrogen-lithium fusion kinetic energy into DC electric power via electron vibration by gravity waves.

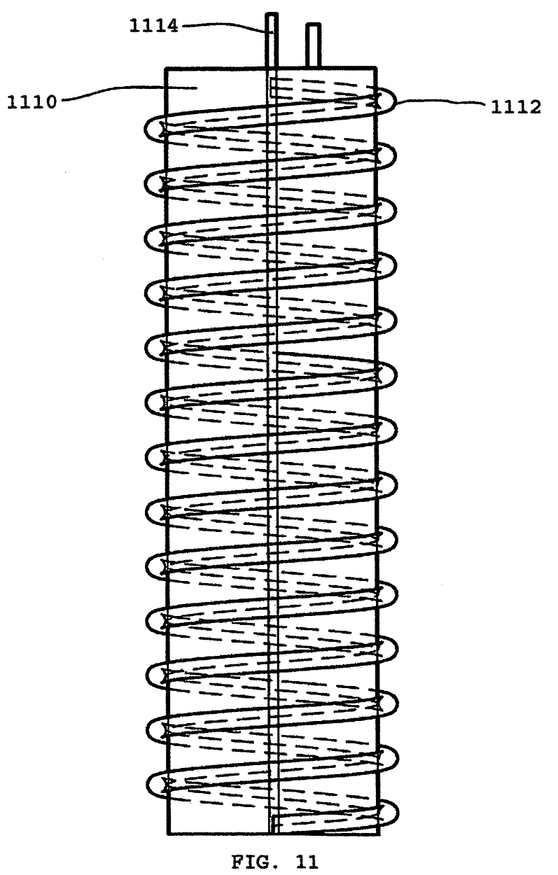

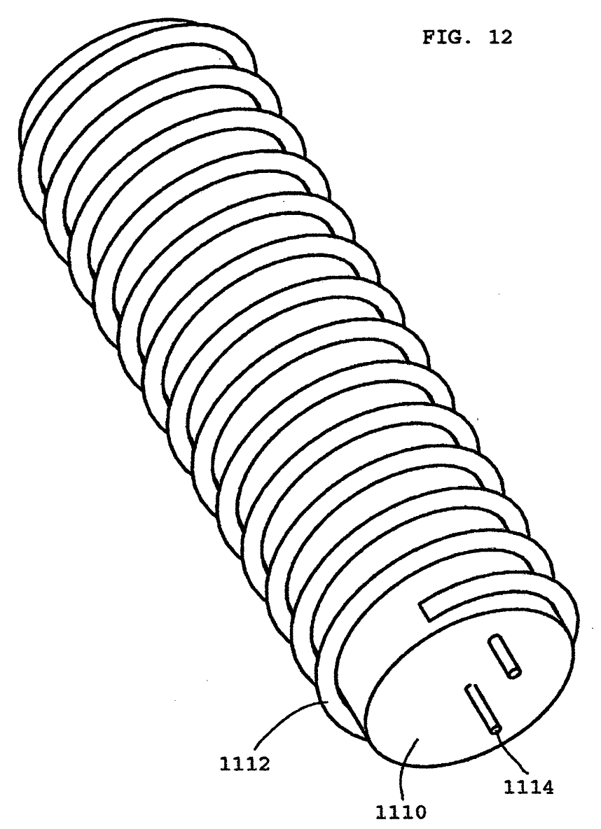

In the Electrogravity Generator, the fusion kinetic energy of the helium ions created by the Hydrogen-Lithium Fusion Device is first transferred into vibrating the electrons in a set of conducting rods (FIG. 11, ref. 1110) by the Type II gravity exerted by the helium ions on the electrons.

The vibration energy of the electrons is then transferred into the electric field energy of a DC electric current in the conducting rods. The energy is transferred by making the electrical motion of electrons in the conducting rods similar to the vibration motion experienced by the electrons as a result of the Type II gravity exerted by the helium ions.

The desired electron motion in a conducting rod is created by first applying a DC electric field to the conducting rod. The electrons in the conducting rod will then be set in motion parallel to the conducting rod. Then by inducing magnetic field lines in the conducting rod that run parallel to the conducting rod, the electrons set in motion by the DC electric field will spiral around the magnetic field lines. This mimics the gravitational motion of the electrons, enabling the gravitational vibration energy of the electrons to be transferred into DC electric current energy.

The magnetic field lines are induced in a conducting rod by coiling a wire 1112 around the conducting rod 1110 in effect creating a solenoid. By applying a DC electric current to the solenoid circuit, the solenoid current creates magnetic field lines in the conducting rod that run generally parallel to the conducting rod.

### Experimental Plan for Proof of Concept

This section presents an experimental plan to prove the feasibility of the Electrogravity Generator. The experiment requires a Hydrogen-Lithium Fusion Device, two electric circuits, and a set of conducting elements. The equipment list is summarized below.

### Equipment for Experimental Proof of Concept

### Facility

Space Environmental Effects Facility, Marshall Space Flight Center, Huntsville, Ala.

### Hydrogen-Lithium Fusion Device

Proton beam energy 307 keV.
Proton beam current between 10 and 40 μA.
99.9% pure lithium foil target 250 microns thick.
Target area ending in a steel six-way cross vacuum chamber.

### DC Power Supplies

Solenoid circuit connected to a vacuum chamber bypass connector.
Detection circuit connected to a vacuum chamber bypass connector.

### Detection Equipment

A circuit consisting of a set of conducting elements wired in series connected to a vacuum chamber bypass connector and then to a power supply and set of power resistors.
A voltmeter to measure DC voltage across the vacuum chamber bypass connector.
An ammeter to measure DC electric current in the circuit.

A conducting element includes an insulated 8 gauge copper solenoid 1112 that is 7 inches long that surrounds a 1 inch diameter conducting rod 1110, also 7 inches long with a central return wire 1114. Alternatively, the conducting element might be a 5.08 cm diameter, 6.35 mm thick wafer of Silicon Carbide doped with Nitrogen. The alternative conducting element is centered behind the target and positioned at horizontal in close proximity to the target holder. The conducting element is positioned so as to reduce the number of helium ions impacting the surface of the conducting element.

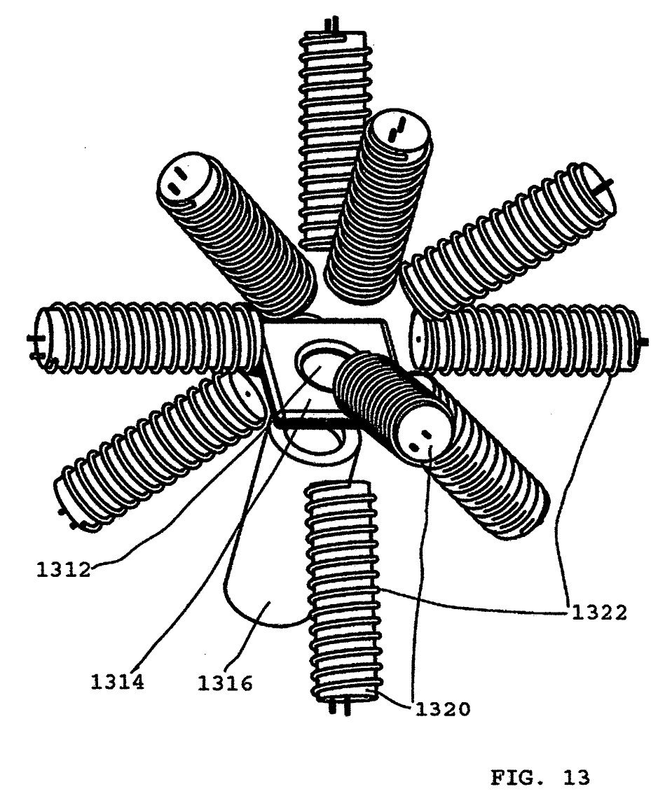

A total of 11 conducting elements wired in series are placed in ceramic holders which align the conducting elements with the target at radial positions, as generally depicted in FIG. 13. The conducting elements could, alternatively, be wired in parallel or as separate circuits. The conducting element circuit is connected to a bypass connector in a six-way cross vacuum chamber flange. The external section of the circuit is connected to a power supply and one or more power resistors.

The solenoids surrounding the conducting rods are also wired in series and are connected to another bypass connector. Again, the wiring could be in parallel or as separate circuits. The external section of the circuit is connected to a power supply and one or more power resistors. In FIG. 13, the lithium target 1312 is held by the target holder 1314. A nozzle 1316 directs protons at the target 1312. Gravity effects propagate in directions radial to the target, along the axes of the conducting rods 1320. In a production device, it is expected that more rods will be more efficient.

A DC electric current is applied to the solenoid circuit to create magnetic field lines in each conducting rod that run parallel to the conducting rod. The strength of the magnetic field can be adjusted by increasing or decreasing the applied DC current.

A second DC electric current is applied to the conducting element circuit. When the magnetic field lines of the solenoids are present, the electrons move in a spiral motion around the magnetic field lines similar to the gravitational vibration of the electrons.

A voltmeter measures the DC voltage across the conducting element section of the circuit and an ammeter measures the DC electric current in the conducting element circuit. When the hydrogen-lithium fusion device is turned on, the helium ions vibrate the electrons in the conducting rods and the electron vibration amplifies the DC electric field in the conducting element circuit. Operation of this apparatus will provide experimental proof for the feasibility of the Electrogravity Generator.

### Electric Power Production

A Hydrogen-Lithium Fusion Device (1312, 1314, 1316) is used as the power source for the Electrogravity Generator. In a semiconductor material, the electron energy is transferred into DC electric power when the energy of a valence electron in a quantum potential well reaches the band gap energy and the electron jumps from the valence band to the conduction band. If the band gap energy equals or exceeds the energy of a photon emitted at the electron gravity wavelength, the electron can give up its energy to the DC electric field in the conducting element and drop back into the valence band. For example, the theoretical band gap energy of Gallium Phosphide is about 2.26 eV. The theoretical band gap may be larger than the practical band gap in most semiconductors.

A spherical grouping of conducting elements 1320 FIG. 13 is positioned in the vacuum chamber of the ion accelerator such that their length axes point at the lithium target. A conducting element includes a solenoid 1322 that surrounds a conducting rod 1320. The conducting elements are centered on the target and positioned in close proximity surrounding the target holder. The solenoids and the conducting rods are wired to form one or more circuits.

A spherical grouping of conducting elements alternatively may include a semiconductor material such as Silicon Carbide doped with Nitrogen. The conducting elements are centered on the target and positioned in close proximity surrounding the target holder. The conducting elements are wired to form one or more circuits

When a DC current is applied to the solenoid circuit, magnetic field lines are created in each conducting rod that run generally parallel to the conducting rod. The same or separate electric current is applied to the conducting rod circuit, preferably a DC circuit. The motion of the electrons in the conducting rods is then similar to the gravitational vibration of the electrons caused by the helium ion fusion byproducts of the Hydrogen-Lithium Fusion Device.

When the Hydrogen-Lithium Fusion Device operates, the helium ion fusion byproducts exert Type II wave gravity on the electrons in the conducting rods. The Type II gravity waves only interact with particles of equal or smaller mass such as an electron or unit of the fabric of space and as such do not affect the larger atomic nuclei.

The helium ion byproducts of the fusion reactions are expelled symmetrically with respect to the target. The movement of the helium ions creates Type II gravity waves that vibrate electrons in the conducting rods so as to enable kinetic energy transfer from the helium ions to the electrons in the conducting rods.

The arrangement, shape, volume, mass, and material of the conducting elements are designed to maximize the number of electrons vibrated by the Type II gravity waves created by the helium ions. For example, the conducting elements can be copper rods with an insulated copper solenoid.

As a result of the magnetic field and the prior DC electric current applied to the conducting rods, the electrons travel in a spiral motion around the magnetic field lines. Since the electrical motion of the electrons is similar to the gravitational vibration of the electrons, the electron gravitational vibration energy is transferred into electron electrical energy, thus amplifying an electrical circuit.

The amount of helium ion kinetic energy transferred into electric power is determined in part by the number of individual fusion reactions taking place and the efficiency of transferring fusion kinetic energy via the Type II gravity experienced by electrons in the conducting elements.

The electrical energy required to create the proton beam in the Hydrogen-Lithium Fusion Device and the solenoid circuit should be less than the fusion kinetic energy transformed into electric power. The released fusion kinetic energy that is transferred into electric power is then able to sustain all the power requirements of the Electrogravity Generator while still generating excess electric power.

After the start-up or priming power consumption of the Hydrogen-Lithium Fusion Device, the Electrogravity Generator is self sustaining as long as hydrogen gas and lithium are available to maintain the fusion reaction.

A conducting element may also be a semiconductor material that is conductive. For example, while pure Gallium Phosphide is an insulator, when doped with Zinc the semiconductor becomes electrically conductive. For Gallium Phosphide doped with Zinc, an ohmic contact may be a gold selenium alloy, while an elemental contact may be a conductor such as aluminum. Another example is Silicon Carbide doped with Nitrogen. For Silicon Carbide doped with Nitrogen an elemental contact may be Nickel. The conductive property in the conducting elements facilitates the amplification of the current and reduces heat generation in the semiconductor material as a result of the amplified electric current.

Silicon Carbide doped with Nitrogen (SiC—N) is a strong candidate for a proof of concept experiment since Silicon Carbide is commonly used for high power applications such as Schottky Diodes, Schottky Rectifiers, and High Voltage Field Effect Transistors. (See B. Jayant Baliga, Silicon Carbide Power Devices, North Carolina State University, USA) The kinetic energy of the helium ions is transferred by Type II wave gravity to the electrons in the valence band of a semiconductor material such as Silicon Carbide doped with Nitrogen by means of quantum potential wells which are a characteristic of a semiconductor.

The arrangement, shape, volume, mass, and material of the conducting elements are designed to maximize the number of electrons in quantum potential wells which may gain energy transferred by the Type II wave gravity exerted by the helium ions. For example, a conducting element can be Silicon Carbide doped with Nitrogen, Zinc Telluride doped with Vanadium, or other semiconductor materials which expose the valence electrons to quantum potential wells and have a band gap energy that equals or exceeds about 2.26 eV.

This section presents an experimental plan to prove the feasibility of the Electrogravity Generator. The experiment requires a Hydrogen-Lithium Fusion Device (“HLFD”), an electric circuit, an applied DC electric field, and a conducting element made of a semiconductor material such as Silicon Carbide doped with Nitrogen (SiC-N). The equipment is summarized in the table below.

Surplus electric power produced by the Electrogravity Generator can be delivered to external applications by well-known methods such as a power grid.

### Illustrative Electric Power Production

Assumptions:

Ion type=Proton

Ion accelerator=Pelletron

Proton energy=307 keV

Beam current=10 mA (6.2 10¹⁶ protons/sec)

Standard lithium target (₆Li: ₇Li)=(7.5%:92.5%)

Fusion efficiency=100%

$$Fusion kinetic energy transfered per second = Fusion efficiency * Protons \text{/} sec * Fusion Energy = 1.0 * 6.2 {10}^{16} * ( 0.075 * 4.0 Mev + 0.925 * 17.2 Mev ) = 1.0 {10}^{18} Mev \text{/} sec = 1.6 {10}^{5} joules \text{/} sec = 160 kilowatts$$

### Gravity Portal Application

### Behavior of the Fabric of Space

According to the gravity theory based on mass-energy equivalence, the fabric of space is quantized into discrete units which have a rest mass equal to 2 proton masses, a characteristic wavelength of 2 millimeters, and the capability to store and transfer kinetic energy as vibration energy.

As kinetic energy is transferred into the fabric of space, the fabric of space contracts according to:

r₂=r₁(1−v²/c²)^{1/2},

where r₂ is the unit of distance in the contracted fabric of space, r₁ is the unit of distance in the original fabric of space, v measures the kinetic energy transferred into the fabric of space, and c is the speed of light.

While adding to the kinetic energy of an object results in an increase of its speed, adding kinetic energy to the fabric of space results in a contraction of the fabric of space by the first-order singularity of Type II gravity.

Since the first-order singularity of Type II gravity is very large, the gravity theory based on mass-energy equivalence predicts that the contraction of the fabric of space occurs very quickly so as to enable an effective transfer speed that may exceed the speed of light.

### Concept of Gravity Portal

The Gravity Portal is a device for sending and/or receiving electromagnetic waves or physical objects through space that is contracted in the intended transfer direction. The device uses hydrogen-lithium fusion in order to transfer kinetic energy from the helium ion fusion byproducts into the fabric of space. The helium ions are focused in the intended transfer direction and the kinetic energy transferred into the fabric of space contracts the fabric of space in the transfer direction. The effective speed of electromagnetic waves transferred through the contracted space is greater than the speed of light. The effective speed of physical objects transferred through the contracted space is dependent on the speed of the objects in the contracted space and the space contraction ratio, and as a result may exceed the speed of light.

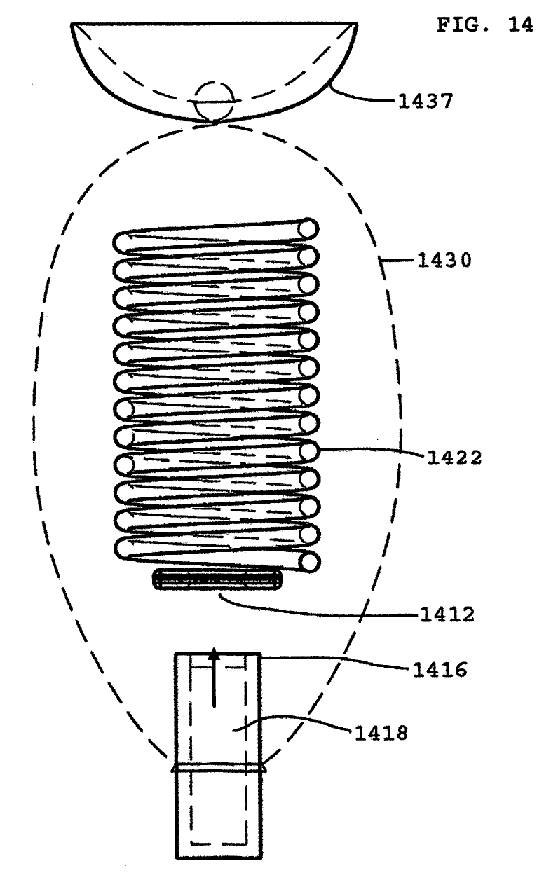

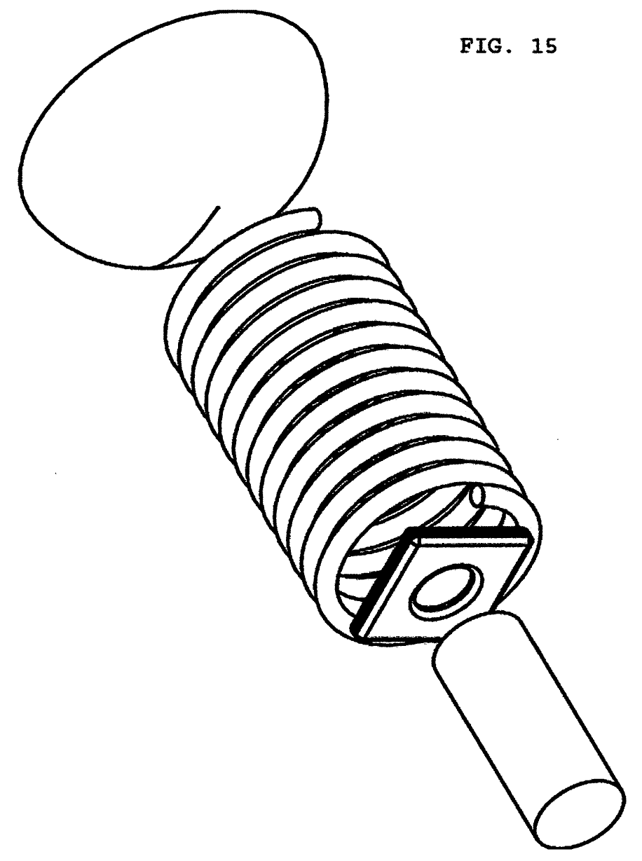

In the Gravity Portal device of FIGS. 14-15, the fusion kinetic energy and rest mass of the helium ions created by the Hydrogen-Lithium Fusion Device distort the fabric of space surrounding the helium ions and result in Type II gravity waves for objects that are of equal or smaller size than the helium ion. This allows the helium ions to vibrate the units of the fabric of space which have a rest mass of 2 proton masses.

Helium ions produced by collision of protons 1418 directed by a nozzle 1416 with the target 1412 are focused toward the front of the Gravity Portal by a solenoid 1422 that is aligned in the intended transfer direction. A vacuum containment 1420 surrounds the fusion target, solenoid and related materials. The solenoid also causes the helium ions to spiral around the magnetic field lines. The spiral motion of the helium ions enables the transfer of kinetic energy from the helium ions into the units of the fabric of space in the intended transfer direction, along an axis through the nozzle 1416, the solenoid 1422 and transmitter 1437.

The kinetic energy transferred into the fabric of space via the Type II gravitational vibration of the fabric of space contracts the fabric of space in the intended transfer direction.

By contracting the fabric of space in the intended transfer direction, the Gravity Portal enables electromagnetic waves or physical objects to be sent and/or received in the intended transfer direction at an effective transfer speed that may exceed the speed of light.

The effective transfer speed is defined as the transfer speed in the contracted fabric of space divided by the space contraction ratio. The space contraction ratio is defined as the unit of distance in the fabric of space after it is contracted divided by the unit of distance in the fabric of space before it is contracted.

The Gravity Portal can be used to enable a telescope, a view screen on a spacecraft, a space communication system, a propulsion system, a delivery system, a gravity computer, or any other device or system that requires the transfer of electromagnetic waves or objects at effective transfer speeds that may exceed the speed of light.

### Single Gravity Portal

The helium ions created by the Hydrogen-Lithium Fusion Device are focused toward the front of the Gravity Portal and transfer their kinetic energy to the units of the fabric of space in front of the Gravity Portal in FIGS. 14 and 15. The continuous release of helium ions creates Type II wave gravity that vibrates the units in the fabric of space in front of the Gravity Portal at the gravity wavelength of the units.

The kinetic energy of the helium ions transferred into the fabric of space causes the units of the fabric of space in front of the Gravity Portal to become relativistic and thus contract the fabric of space in front of the Gravity Portal instantaneously as required by the gravity theory based on mass-energy equivalence.

Since electromagnetic waves move through contracted space at the speed of light, the effective speed of electromagnetic waves transferred through the contracted fabric of space is the speed of light divided by the space contraction ratio. Thus the effective transfer speed is greater than the speed of light, as viewed from an external frame of reference such as the portal's initial frame of reference.

The effective speed of physical objects transferred through the contracted fabric of space is the speed of the object in the contracted space divided by the space contraction ratio. Thus the effective transfer speed may be greater than the speed of light.

As a result, the Gravity Portal is able to send and/or receive electromagnetic waves or physical objects through the contracted fabric of space in the intended transfer direction at an effective transfer speed that may exceed the speed of light.

### Multiple Gravity Portals

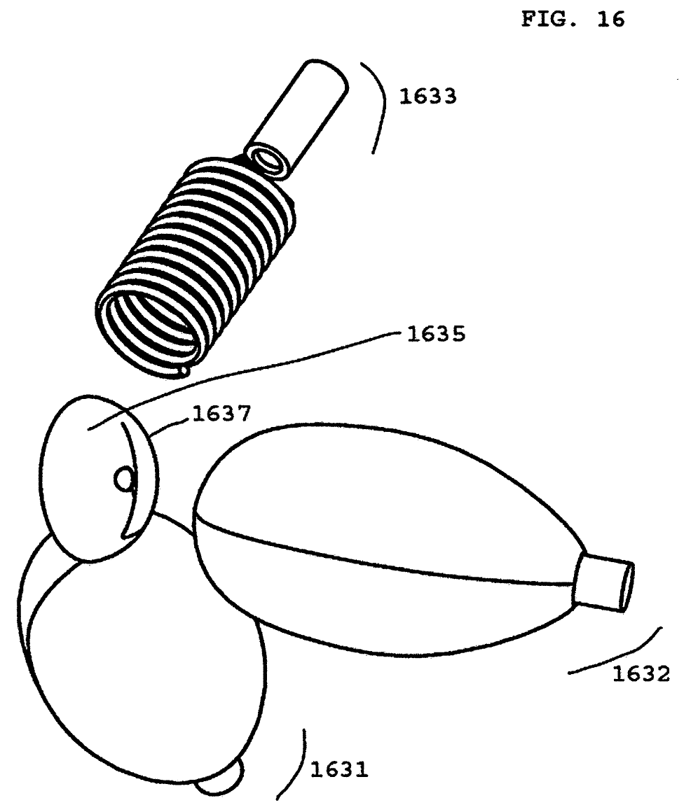

The number of Gravity Portals per Gravity Portal array FIG. 16 is determined in part by the availability of existing Gravity Portals, the efficiency of creating the contraction of the fabric of space, and the accuracy of the intended transfer direction. The term Gravity Portal array is used subsequently as a generic term to denote any configuration that contains one or more Gravity Portals.

As an illustrative example, the inventors describe a Gravity Portal array that contains three Gravity Portals 1631-33 which are symmetrically placed around a central axis with the axis of each Gravity Portal intersecting at a point 1635 directly above the array. (Gravity portal 1633 is illustrated without a vacuum containment, so it more closely resembles FIG. 15.)

For electromagnetic waves or radiant energy, a dish antenna 1637 and transmitter/receiver are aimed upward and centered within the Gravity Portal array below the Gravity Portal axis intersection point. Any electromagnetic waves that travel through the contracted fabric of space are able to be received in near real-time over large distances. Near real-time broadcast of signals over large distances can also be achieved by inputting a transmission signal into the contracted fabric of space via the transmitter/receiver and dish antenna.

For physical objects, the dish antenna and transmitter/receiver are replaced with a device or system to transfer objects into the contracted fabric of space. If the Gravity Portal array is part of a vessel, the vessel may also be accelerated into the contracted fabric of space.

For small space contraction ratios, the Gravity Portal array must be either very large or embedded in a large or massive object since Type I and Type II gravity forces are also acting that would tend to accelerate the Gravity Portal array into the contracted fabric of space in the intended transfer direction.

Detailed Description of Gravity Portal

The proton-lithium fusion energy source of the Gravity Portal is supplied by the Hydrogen-Lithium Fusion Device 1412, 1416, 1418.

A focusing solenoid 1422 is positioned at the rear of the target holder within a vacuum chamber 1430. The magnetic field of the solenoid focuses the helium ions created by the Hydrogen-Lithium Fusion Device in the direction of intended transfer. The solenoid also causes the helium ions to spiral around the magnetic field lines that are in the intended travel direction.

Fusion kinetic energy from helium ions that travel in the direction opposite to the intended travel direction can alternatively be harnessed by conducting elements as in the Electrogravity Generator.

The spiral motion of the helium ions and the rest mass and kinetic energy of the helium ions create Type II wave gravity that vibrates the units of the fabric of space in front of the Gravity Portal and as a result transfers kinetic energy into the fabric of space.

The fabric of space is quantized into discrete units where each unit of the fabric of space has a rest mass equal to 2 proton masses (2 mₚ), a characteristic length equal to 2 millimeters, and the capability to store and transfer kinetic energy as vibration energy.

The helium ions are projected toward a region of the fabric of space denoted as the transfer region in front of the Gravity Portal. The rest mass m_{A} of the fabric of space transfer region is equal to the number of units of the fabric of space in the transfer region multiplied by the rest mass of a unit of the fabric of space.

m_{A}=Number of units in transfer region*2 mₚ

The mass and kinetic energy of the helium ions create Type II gravity waves that vibrate the units of the fabric of space in front of the Gravity Portal and as a result transfer kinetic energy into the fabric of space transfer region.

The amount of kinetic energy KE transferred into the fabric of space transfer region is specified by the parameter v_{A}/c according to mass-energy equivalence:

KE=m_{A}c²{(1−v_{A}²/c²)^{-1/2}−1},

where m_{A} is the rest mass of the fabric of space transfer region, v_{A} measures the amount of kinetic energy transferred into the fabric of space transfer region, and c is the speed of light. As the transferred kinetic energy increases, the “v_{A}/c” parameter increases toward 1.

The kinetic energy transferred into the fabric of space transfer region contracts the fabric of space in the intended transfer direction according to the gravity theory based on mass-energy equivalence:

r₂=r₁(1−v_{A}²/c²)^{1/2},

where r₂ is the unit of distance in the contracted fabric of space, r₁ is the unit of distance in the original fabric of space, v_{A} measures the amount of kinetic energy transferred into the fabric of space transfer region, and c is the speed of light.

When the fabric of space is contracted in the intended transfer direction, electromagnetic waves are contracted along with the fabric of space towards the Gravity Portal. This allows the Gravity Portal to act as a near real-time telescope or communication device.

Electromagnetic waves that are transmitted through the Gravity Portal travel at an effective transfer speed that is the speed of light divided by the space contraction ratio. If the fabric of space is contracted, the effective transfer speed is greater than the speed of light.

Physical objects that are transferred through the Gravity Portal in the intended transfer direction travel at an effective transfer speed that is the speed of object in the contracted fabric of space divided by the space contraction ratio. As a result, the effective transfer speed may be greater than the speed of light.

### Illustrative Gravity Portal Examples

Assumptions:

Mass of physical object m_{B}=10⁴ kg (11 tons)

Initial speed of physical object v_{B}=0 m/sec

Distance of Gravity Portal to fabric of space transfer region r_{B}=5 m

Diameter of fabric of space transfer region=1 m

Diameter of fabric of space unit=2 mm

Thickness of transfer region=1 unit

Units in transfer region=2.5*10⁵

Rest mass of proton mₚ=1.67*10⁻²⁷ kg

Rest mass of fabric of space unit=2 mₚ

Rest mass of transfer region m_{A}=2.5*10⁵*2 mₚ

Gravitational constant G=6.67*10⁻¹¹ Nm²/kg²

Earth gravity g=9.8 m/sec²

Speed of light=3.0*10⁸ m/sec

Light year=9.46*10¹⁵ m

Space contraction when effective gravity force is the same magnitude as earth gravity:

$$Type II gravity force = 1.17 / 2 π {Gm}_{B} {m}_{B} / {r}_{B}^{2}$$

$$\begin{matrix}\frac{Type II gravity force}{space contraction ratio} = earth gravity force \\ 1.17 / 2 π {Gm}_{B} {{m}_{B} ( \frac{1 - {v}_{A}^{2}}{{c}^{2}} )}^{- 1 / 2} / {r}_{B}^{2} \\ = {r}_{B}^{2} = {m}_{B} g\end{matrix}$$

$$\frac{Type II gravity force}{space contraction ratio} = earth gravity force \\ 1.17 / 2 π {Gm}_{B} {{m}_{B} ( \frac{1 - {v}_{A}^{2}}{{c}^{2}} )}^{- 1 / 2} / {r}_{B}^{2} = {m}_{B} g \\ Space contraction raito = {( \frac{1 - {v}_{A}^{2}}{{c}^{2}} )}^{1 / 2} = 5.07 * {10}^{- 10} \\ \begin{matrix}Total kinetic energy requried = {m}_{A} {c}^{2} \{ {( 1 - {v}_{A}^{2} / {c}^{2} )}^{- 1 / 2} - 1 \} \\ = 1.48 * {10}^{5} Joules \\ ( 148 Kilowatts or \\ 9.24 * {10}^{17} Mev )\end{matrix} \\ \begin{matrix}Contracted light year = Light year * Space contraction ratio \\ = 4.80 * {10}^{3} km\end{matrix}$$

Space contraction when gravity force results from logarithmic singularity:

$$Logarithmic singularity equation \text{:} mB / m A = \frac{( 1 + vB / c )}{( 1 - vA / C )}$$

$$\begin{matrix}Space contraction ratio = {( 1 - vA 2 / c 2 )}^{1 / 2} \\ = {\{ 2 ( \frac{1 + {v}_{B}}{c} ) \frac{{m}_{A}}{{m}_{B}} - {( \frac{1 + {v}_{B}}{c} )}^{2} \frac{{m}_{A}^{2}}{{m}_{B}^{2}} \}}^{1 / 2} \\ = 4.09 * {10}^{- 13}\end{matrix}$$

$$\begin{matrix}Total kinetic energy required = {m}_{A} {c}^{2} \{ {( 1 - {v}_{A}^{2} / {c}^{2} )}^{- 1 / 2} - 1 \} \\ = 2.04 * {10}^{7} Joules ( 20.4 \\ Megawatts or 1.27 * {10}^{20} Mev )\end{matrix}$$

$$\begin{matrix}Contracted light year = Light year * Space contraction ratio \\ = 3.87 km\end{matrix}$$

### Gravity Propulsion Engine Application

Concept of Gravity Propulsion Engine

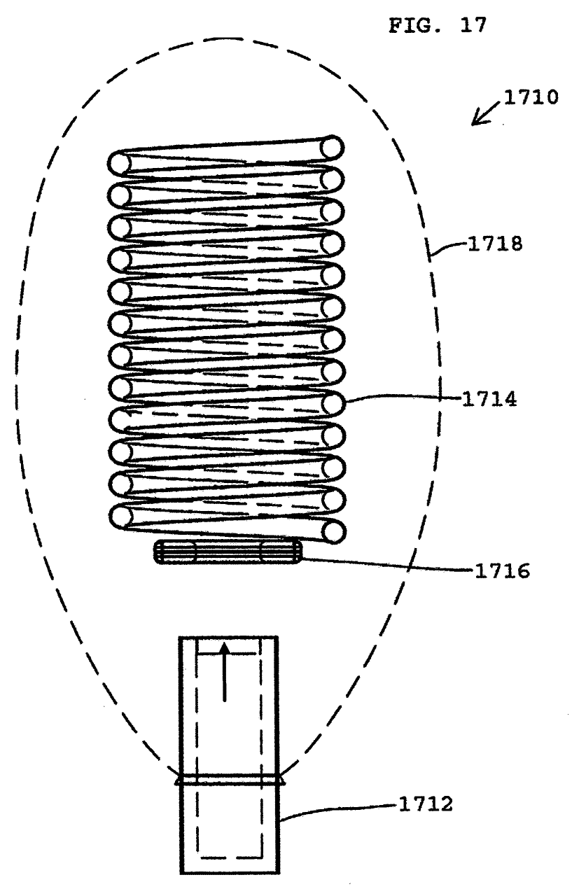

The Gravity Propulsion Engine 1710 illustrated in FIG. 17 achieves propulsion using gravity exerted by the units of the fabric of space and is predicated on a gravity theory based on mass-energy equivalence. It harnesses hydrogen-lithium fusion to transfer kinetic energy from resulting helium ions into the units of the fabric of space. The helium ions are focused in the intended travel direction. The kinetic energy in the units of the fabric of space then exerts a gravitational force that propels the vessel in the intended travel direction. The kinetic energy in the fabric of space also contracts the fabric of space in the intended travel direction so that the effective speed is increased. The invention has two modes of propulsion that depend on the amount of kinetic energy transferred into the units of the fabric of space. A low to moderate speed mode is obtained by transferring a limited amount of kinetic energy. Transferring a much larger amount of kinetic energy engages a logarithmic singularity in the gravitational force. This mode provides an extremely high rate of speed that can approach the speed of light. The contraction of the fabric of space in the intended travel direction results in an effective speed that can exceed the speed of light.

The Gravity Propulsion Engine transfers the kinetic energy released by hydrogen-lithium fusion into the units of the fabric of space via the vibration of the units by gravity waves. The kinetic energy transferred into the units of the fabric of space enables two modes of gravity propulsion. In addition, the kinetic energy transferred into the units of the fabric of space contracts the fabric of space in the intended travel direction, thus allowing the effective speed to exceed the speed of light.

In the Gravity Propulsion Engine, the fusion kinetic energy and rest mass of the helium ions created by the Hydrogen-Lithium Fusion Device distort of the fabric of space surrounding the helium ions and results in Type II gravity waves for objects that are of equal or smaller size than the helium ion. This allows the helium ions to vibrate the units of the fabric of space which have a rest mass of 2 proton masses.

As in the Gravity Portal device, the helium ions are focused toward the front of the Gravity Propulsion Engine so as to transfer kinetic energy into the units of the fabric of space in front of the Gravity Propulsion Engine.

The kinetic energy transferred into the units of the fabric of space via the Type II gravitational vibration of the units cause the units to become relativistic. The relativistic units then exert both a Type I and a Type II classical type gravity force on the vessel that contains the Gravity Propulsion Engine(s). The term vessel is used subsequently as a generic term to denote any apparatus that contains one or more Gravity Propulsion Engines. For example, a vessel can be an aircraft or spacecraft.

There are two modes of propulsion for the Gravity Propulsion Engine which the inventors refer to as Type I drive and Type II drive. In a Type I drive, the Gravity Propulsion Engine transfers a large amount of energy into the units of the fabric of space so as to engage one of the logarithmic singularities in the Type I gravity force. This logarithmic singularity in the Type I gravity force propels the vessel at an extremely high speed. In a Type II drive, the Gravity Propulsion Engine transfers a limited amount of energy into the units of the fabric of space so as to enable the Type II gravity force to propel the vessel at low to moderate speed.

### Single Gravity Propulsion Engine

The helium ions created by a Hydrogen-Lithium Fusion Device are focused toward the front of the Gravity Propulsion Engine and transfer their kinetic energy to the units of the fabric of space in front of the Gravity Propulsion Engine.

The continuous release of helium ions creates Type II gravity waves that vibrate the units of the fabric of space in front of the Gravity Propulsion Engine at the gravity wavelength of the units.

The kinetic energy of the helium ions transferred into the fabric of space causes the units of the fabric of space in front of the engine to become relativistic and thus exert both a Type I and Type II classical type force on the engine.

### Type I Propulsion Drive

When the kinetic energy transferred into the units of the fabric of space in front of a vessel reaches the threshold kinetic energy required to engage one of the Type I logarithmic singularities, the vessel experiences an extremely large gravitational force that propels the vessel forward at a speed that can approach the speed of light.

The kinetic energy transferred into the units of the fabric of space also causes a contraction of the fabric of space in front of the vessel as required by the gravity theory based on mass-energy equivalence. This enables the vessel to move at an effective speed that is far greater than the speed of light.

The Type I logarithmic singularity in the gravity force transfers energy and momentum to the vessel from the fabric of space.

### Type II Propulsion Drive

Type II drive is enabled by transferring a limited amount of kinetic energy into the units of the fabric of space. The kinetic energy transferred into the units results in the units becoming relativistic.

The Type II gravity force exerted by the relativistic units of the fabric of space on a large object such as a vessel is extremely large compared to the classical gravity force. The Type II gravity force is further increased by the space contraction caused by the kinetic energy of the fabric of space as required by the gravity theory based on mass-energy equivalence. The combination of the Type II gravity force and the space contraction in the intended travel direction is then sufficient to propel the vessel at low to moderate speed.

The Type II gravity force transfers energy and momentum to the vessel from the fabric of space.

### Multiple Gravity Propulsion Engines

The number of Gravity Propulsion Engines per vessel is determined in part by forward propulsion, steering, deceleration, reverse propulsion, and redundancy requirements. As an illustrative example, an engine configuration in which three Gravity Propulsion Engines are used to provide forward propulsion and steering, and one Gravity Propulsion Engine is used to provide deceleration and reverse propulsion, is described.

If more than one Gravity Propulsion Engine is used for deceleration and reverse propulsion, they can be configured similar to the forward Gravity Propulsion Engines. In this way they can provide reverse propulsion, reverse steering, deceleration, and redundancy.

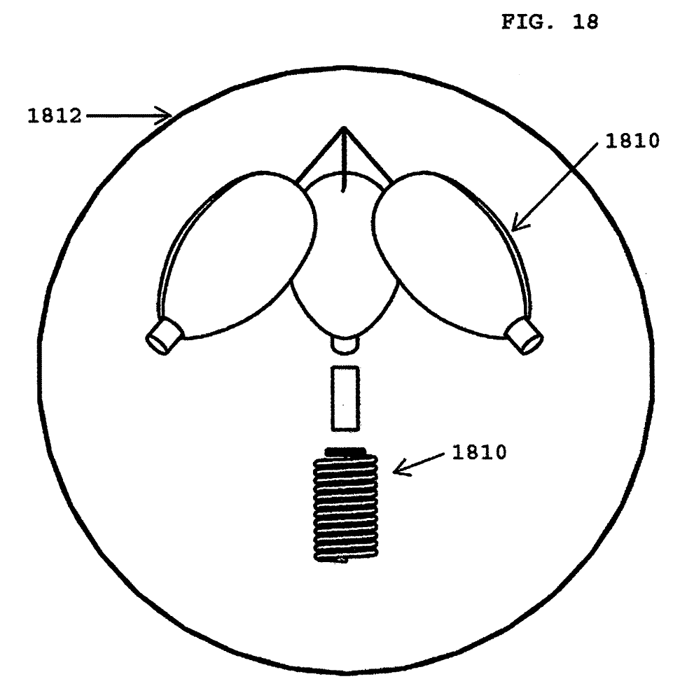

In FIG. 18, three Gravity Propulsion Engines that provide forward propulsion are orientated forward with respect to the front of the vessel. The Gravity Propulsion Engines are symmetrically placed around the central axis of a vessel, with the axis of each Gravity Propulsion Engine intersecting at a point directly in front of the vessel.

The transfer of kinetic energy into the units of the fabric of space in this location allows the entire mass of the engines or vessel to be accelerated uniformly when Type I drive or Type II drive is engaged.

A change in direction can be achieved by reducing or increasing the number of helium ions being created by the Hydrogen-Lithium Fusion Device in one or more of the Gravity Propulsion Engines. This will shift the kinetic energy transfer point in the units of the fabric of space with respect to the vessel and change the direction of the Type I or Type II gravity force and the contraction of the fabric of space.

The Gravity Propulsion Engine(s) that provide deceleration and reverse propulsion are placed at the bottom of the vessel at its center or symmetrically about the vessel's central axis. The transfer of kinetic energy into the units of the fabric of space behind the vessel allows the entire mass of the vessel to be decelerated uniformly after the Type I or Type II drive has been engaged.

### Detailed Description of Single Gravity Propulsion Engine

The proton-lithium fusion energy source 1712 in FIG. 17 of the Gravity Propulsion Engine 1710 is supplied by a Hydrogen-Lithium Fusion Device.

A focusing solenoid 1714 is positioned at the rear of the target holder 1716 within the vacuum chamber 1718 of the Hydrogen-Lithium Fusion Device. The magnetic field of the solenoid 1714 focuses the helium ions created by the Hydrogen-Lithium Fusion Device in the direction of intended transfer. The solenoid also causes the helium ions to spiral around the magnetic field lines that are in the intended travel direction.

Fusion kinetic energy from helium ions that travel in the opposite direction of intended travel can be harnessed by conducting elements as in the Electrogravity Generator.

The fabric of space is quantized into discrete units where each unit of the fabric of space has a rest mass equal to 2 proton masses (2 mₚ), a characteristic length equal to 2 millimeters, and the capability to store and transfer kinetic energy as vibration energy.

The helium ions are projected toward the front of the Gravity Propulsion Engine 1710 FIG. 17 into a region of the fabric of space denoted as the transfer region. The rest mass m_{A} of the fabric of space transfer region is equal to the number of units in the transfer region multiplied by the rest mass of a unit of the fabric of space.

m_{A}=Number of units in transfer region*2 mₚ

The mass and kinetic energy of the helium ions create Type II gravity waves that vibrate the units of the fabric of space in front of the Gravity Propulsion Engine 1710 and as a result transfer kinetic energy into the fabric of space transfer region.

The amount of kinetic energy KE transferred into the fabric of space transfer region is specified by the parameter v_{A}/c according to mass-energy equivalence:

KE=m_{A}c²{(1−v_{A}²/c²)^{-1/2}−1},

where m_{A} is the rest mass of the fabric of space transfer region, v_{A} measures the amount of kinetic energy transferred into each unit of the fabric of space transfer region, and c is the speed of light. As the kinetic energy increases, the “v_{A}/c” parameter increases toward 1.

The kinetic energy transferred into the fabric of space transfer region contracts the fabric of space in the intended travel direction as required by the gravity theory based on mass-energy equivalence:

r₂=r₁(1−v_{A}²/c²)^{1/2},

where r₂ is the measure of distance in the contracted fabric of space and r1 is the measure of distance in the original fabric of space, vA measures the amount of energy transferred into the fabric of space transfer region, and c is the speed of light.

For a Type II drive, a limited amount of kinetic energy is transferred into the units of the fabric of space. This allows the units in the fabric of space transfer region to exert a Type II gravity force on the vessel and to contract the fabric of space in the intended travel direction so as to propel the vessel at low to moderate speed.

In the gravity theory based on mass-energy equivalence if the kinetic energy transferred into the fabric of space is such that v_{A}/c≈1, the Type II gravity force F_{G} exerted by the fabric of space transfer region on the vessel is such that the rest mass of the fabric of space transfer region appears as the rest mass of the vessel. If we assume that v_{B}/c=0 for simplicity, we have:

F_{G}(r_{B})≈Gm_{B}m_{B}1/2πRe{sin⁻¹(log 4)−sin⁻¹(log 4+iπ)}/r_{B}²,

where r_{B} is the distance from the vessel to the kinetic energy transfer region, G is the gravitational constant, m_{B} is the rest mass of the vessel, Re{ } indicates the real part of the expression, sin⁻¹ is the inverse sine function, v_{B} is the initial speed of vessel, and c is the speed of light.

The combination of the Type II gravity force and the contraction of the fabric of space in the intended travel direction propel the vessel at low to moderate speed. The contraction of the fabric of space in the intended travel direction even enables the vessel to achieve an effective speed that is greater than the speed of light.

For Type I drive, the amount of kinetic energy transferred into the fabric of space transfer region is greatly increased so as to engage one of the eight logarithmic singularities in the Type I gravity force. The equation for this logarithmic singularity is:

m_{B}/m_{A}=(1+v_{B}/c)/(1−v_{A}/c),

where m_{B} is the rest mass of the vessel, m_{A} is the rest mass of the fabric of space transfer region, v_{B} is the speed of the vessel when the logarithmic singularity engages, v_{A} measures the amount of energy transferred into the fabric of space transfer region, and c is the speed of light.

The space contraction factor resulting from the logarithmic singularity is:

(1−v_{A}²/c²)^{1/2}={2(1+v_{B}/c)m_{A}/m_{B}−(1+v_{B}/c)²m_{A}²/m_{B}²}^{1/2},

where m_{A} is the rest mass of the fabric of space transfer region, m_{B} is the rest mass of the vessel, v_{A} measures the amount of energy transferred into the fabric of space transfer region, v_{B} is the speed of the vessel, and c is the speed of light.

When v_{A}/c is sufficiently close to 1, the singularity equation is satisfied and the vessel experiences an extremely strong gravitational force that has a logarithmic singularity. The logarithmic singularity in the Type I gravity force exerted by the fabric of space transfer region on the vessel results in an extremely high rate of speed that can approach the speed of light. The contraction of the fabric of space in the intended travel direction enables the vessel to achieve an effective speed that is greater than the speed of light.

### Detailed Description of Multiple Gravity Propulsion Engines

The number of Gravity Propulsion Engines 1810 per vessel 1812 (FIG. 18) is determined in part by forward propulsion, steering, deceleration, reverse propulsion, and redundancy requirements. As an illustrative example, an engine configuration in which three Gravity Propulsion Engines 1810 are used to provide forward propulsion and steering, and one Gravity Propulsion Engine, depicted without its vacuum containment, is used to provide deceleration and reverse propulsion, is described.

A propulsion array is a generic term for a set of Gravity Propulsion Engines used for forward propulsion and steering and Gravity Propulsion Engines used for deceleration and reverse propulsion of the vessel.

For example, three Gravity Propulsion Engines that provide forward propulsion within a propulsion array are symmetrically placed around the central axis of the vessel and angled upward such that the helium ions are projected to intersect at a point above the vessel.

The Gravity Propulsion Engine(s) used for deceleration projects the helium ions towards the rear of the vessel. The location of the projected helium ions used for deceleration is opposite the intersection point of the ions used for forward propulsion.

By using three Gravity Propulsion Engines for either forward or reverse propulsion, the direction of the vessel can be changed by increasing or decreasing the number of hydrogen ions delivered by the ion accelerator in one or more Gravity Propulsion Engines. Because of the contraction of the fabric of space in the intended travel direction, changes in direction occur in a step-wise fashion.

The shape of the vessel allows for uniform acceleration when Type I drive or Type II drive is engaged.

### Illustrative Examples for Gravity Propulsion Engine

Assumptions:

Mass of vessel m_{B}=10⁴ kg (11 tons)

Initial speed of vessel v_{B}=0 m/sec

Distance of vessel to fabric of space transfer region r_{B}=5 m

Diameter of fabric of space transfer region=1 m

Diameter of fabric of space unit=2 mm

Thickness of transfer region=1 unit

Units in transfer region=2.5*10⁵

Rest mass of proton mₚ=1.67*10⁻²⁷ kg

Rest mass of fabric of space unit=2 mₚ

Rest mass of transfer region m_{A}=2.5*10⁵*2 mₚ

Gravitational constant G=6.67*10⁻¹¹ Nm²/kg²

Earth gravity g=9.8 m/sec²

Speed of light=3.0*10⁸ m/sec

Light year=9.46*10¹⁵ m

Type II drive when effective gravity force is the same magnitude as earth gravity:

$$Type II gravity force = 1.17 / 2 π {Gm}_{B} {m}_{B} / {r}_{B}^{2}$$

$$\begin{matrix}\frac{Type II gravity force}{space contraction ratio} = earth gravity force 1.17 / 2 π {Gm}_{B} {m}_{B} \\ {( \frac{1 - {v}_{A}^{2}}{{c}^{2}} )}^{- 1 / 2} / {r}_{B}^{2} \\ = {m}_{B} g\end{matrix}$$

$$\begin{matrix}Space contraction ratio = {( 1 - {v}_{A}^{2} / {c}^{2} )}^{1 / 2} \\ = 5.07 {*}^{{10}^{- 10}}\end{matrix}$$

$$\begin{matrix}Total kinetic energy required = {m}_{A} {c}^{2} \{ {( \frac{1 - {v}_{A}^{2}}{{c}^{2}} )}^{- 1 / 2} - 1 \} \\ = 1.48 * {10}^{5} Joules ( 148 \\ Kilowatts or 9.24 * {10}^{17} Mev )\end{matrix}$$

Type I drive engages a logarithmic singularity in the effective gravity force:

$$Logarithmic singularity equation \text{:} \frac{{m}_{B}}{{m}_{A}} = ( \frac{1 + {v}_{B}}{c} ) ( \frac{1 - {v}_{A}}{c} )$$

$$\begin{matrix}Space contraction ratio = {( \frac{1 - {v}_{A}^{2}}{{c}^{2}} )}^{1 / 2} \\ = {\{ 2 ( \frac{1 + {v}_{B}}{c} ) \frac{{m}_{A}}{{m}_{B}} - {( \frac{1 + {v}_{B}}{c} )}^{2} \frac{{m}_{A}^{2}}{{m}_{B}^{2}} \}}^{1 / 2} \\ = 4.09 * {10}^{- 13}\end{matrix}$$

$$\begin{matrix}Total kinetic energy required = {m}_{A} {c}^{2 } \{ {( 1 - {v}_{A}^{2} / {c}^{2} )}^{- 1 / 2} - 1 \} \\ = 2.04 * {10}^{7} Joules ( 20.4 \\ Megawatts or 1.27 * {10}^{20} Mev )\end{matrix}$$

$$\begin{matrix}Contracted light year = Light year * Space contraction ratio \\ = 3.87 km\end{matrix}$$

### Some Particular Embodiments

The present invention may be practiced as a method or device adapted to practice the method. One embodiment is a target assembly for use with the proton generator capable of generating a proton beam. The proton beam is projected along an axis and has a transverse dimension at a target position. The target assembly includes a target support locatable at the target position and a lithium target having front and back surfaces. The lithium target is supported by the target support. It has a minimum target thickness measured generally parallel to the proton beam's axis. The target support is configured so that the target has exposed front and back target surfaces that are free of target support material. A target area can be defined by projecting the exposed front surface onto the exposed back surfaces and taking the intersection between areas of the exposed front and back target areas. The target area is the target for the proton beam.

One aspect of this embodiment is limiting the maximum target thickness to less than a first zero of the Bessel J₀ function times the gravity wave length of a proton. It is estimated that the maximum target thickness, by this measure, needs to be less than approximately 2.4 mm.

Alternatively, the maximum target thickness may need to be less than the distance between successive zeros of the Bessel J₀ function times the gravity wave length of a proton. In this case, it is estimated that the maximum target thickness would need to be less than approximately 3.14 mm (“pi” mm.)

Another aspect of this embodiment is limiting the minimum target support thickness to greater than the distance between successive zeros of the Bessel J₀ function times the gravity wave length of a proton. Again, this quantity is estimated to be approximately 3.14 mm (“pi” millimeters.)

Alternatively, the minimum target support thickness may need to be greater than the first zero the Bessel J₀ function times the gravity wave length of a proton. It is estimated that this measure would require a minimum target support thickness of approximately 2.4 mm.

In the embodiments described above, the thickness of the target or target holder is measured along the axis of the proton beam.

Another aspect of this embodiment is that the target support may circumscribe the target area. It may be made of aluminum. The target support may have front and back parts with the target sandwiched between the front and back parts.

The target itself may be comprised of lithium, such as metallic lithium or a lithium containing material, such as lithium oxide or a lithium alloy. The target area of the target may be circular. With a circular target, the target may have a minimum transverse dimension of at least 19.2 mm plus the transverse dimension of the proton beam. The target may have a uniform thickness.

Another embodiment is a target assembly that recombines various features and aspects described above. This target assembly is for use with the proton generator capable of generating a proton beam directs along an axis. The proton beam has a transverse dimension at a target position. The target assembly includes a target support locatable at the target position. It has a minimum target thickness measured generally parallel to the proton beam's axis. The minimum target support thickness is greater than the distance between successive zeros of the Bessel J₀ function times the gravity wave length of a proton. Again, this quantity is estimated to be approximately 3.14 mm. The target assembly further includes a lithium target having front and back surfaces supported by the target support. The target has a maximum thickness of the first zero the Bessel J₀ function times the gravity wave length of a proton. It is estimated that this measure would require a minimum target support thickness of approximately 2.4 mm.

The target support in this embodiment is configured so that the target has exposed front and back target surfaces that are free of target support material. A target area can be defined by projecting the exposed front and back target surfaces along the proton beam axis and taking the intersection of the projected areas. The target area is the target for the proton beam. The target support circumscribes the target area. The target has a minimum transverse dimension of at least 19.2 mm plus the transverse dimension of the proton beam.

As a method, the corresponding embodiment is adapted to making a target assembly for use with a proton generator capable of generating a proton beam along an axis. The proton beam has a transverse dimension that target position. The method includes selecting a lithium target material having front and back surfaces, the target material to target area having a maximum thickness of less than a first zero of the Bessel J₀ function times the gravity wave length of a proton, which is estimated to be approximately 2.4 mm.

An aspect of this method is selecting a target material having a uniform thickness.

Another aspect is selecting a target that includes at least one of metallic lithium, lithium oxide or a lithium alloy.

The target support may be chosen so that the target area is circular. The target support may be aluminum.

The target may be mounted between two parts of the target support so that the target material is sandwiched between the front and back of the target support. Each part of the support may have a thickness according to the criteria above or the combined parts may be sized according to the criteria above.

A related method, which optionally may be practiced using the target support described above, is a method of producing sustained hydrogen-lithium fusion. This method includes selecting a lithium target material having front and back surfaces optionally having dimensions generally described above. The method further includes mounting the target material to a target support to create a target assembly locatable at a target position, optionally having dimensions and characteristics described above. Practicing this method, the selecting and mounting actions are carried out so that the target assembly comprises a lithium target having exposed front and back surfaces free of target support material. The exposed front and back surfaces define a target area as described above. The method further includes projecting the proton beam along the axis and fusing protons in the proton beam with lithium nuclei in the target area.

An aspect of this method is sustaining the hydrogen-lithium fusion for more than 10 minutes without melting the target material.

Another aspect is realizing more than 5% and preferably more than 50% efficiency in combining protons with lithium nuclei. Efficiency may approach 100%, such as achieving 90%, 95% or 99%. The current experiments appear to indicate a high efficiency, given that the target is not melting. Further experiments using particle counting tools calibrated to the expected efficiency range may support refinement of these estimates.

Another related method, which optionally may be practiced using the target support described above or as an enhancement to the method of producing sustained hydrogen-lithium fusion, is a method of generating an amplified electrical current. This method includes harnessing gravity waves induced by fusion byproducts to amplify an electrical current. In one embodiment, the electrical current is a DC current.

An aspect of this method involves the fusion byproducts disbursing along vectors D and amplifying the electrical current by exposing a plurality of conducting elements to gravity waves induced by the fusion byproducts. The conducting elements are aligned to have axes generally along some of the vectors D. In this sense, conducting elements are generally aligned along some of the vectors when the vectors are taken to originate from where the fusion byproducts are generated. This alignment of conducting elements may coincidentally be aligned with the gravity waves induced by the fusion byproducts.

Another aspect of this method includes applying a current to the solenoid wrapping of the conducting elements to create magnetic field lines that run through and are generally aligned with some of the vectors D and the conducting elements. One of skill in the art will appreciate that magnetic field lines are not parallel. A solenoid wrapping of a cylindrical core typically generates magnetic field lines that are generally aligned with the cylinder.

A further aspect of this method includes projecting a proton beam onto a lithium target and creating hydrogen-lithium fusion collisions in said target, whereby the fusion byproducts are helium ions that move away from the target along the vectors D. This aspect of the method may be combined with any other aspects or features of the method of generating an amplified electrical current. It may be understood that the helium ions create gravity waves and the gravity waves amplify the current in the conducting elements.

The corresponding device embodiment amplifies electrical power using gravity waves produced by fusion byproducts. This device includes a beam of accelerated protons and a target comprising lithium that is exposed to the proton beam, whereby fusion collisions between the accelerated protons and lithium atoms create helium ions that move away from the target along vectors D. The device further includes one or more conducting elements generally aligned along some of the vectors D and a primer circuit coupled to the conducting elements that induces an electrical current to be amplified. The device further includes solenoid wrappings around the conducting elements carrying a current and producing magnetic fields with lines through the cores of the conducting elements.

A further aspect of this device includes at least one ion accelerator that generates a beam of accelerated protons by ionizing hydrogen gas and accelerating the resulting ions. This aspect may be combined with the further aspect of helium ions creating gravity waves, wherein the gravity waves produce gravitational attraction and gravitational repulsion of electrons, wherein the electrons transfer gravity wave energy into the electrical current to be amplified.

A different method that harnesses energy from a fusion reaction is a method for transmitting radiant energy at effective transmission speeds that may exceed the speed of light. This method includes transferring kinetic energy from a fusion reaction into a region of the fabric of space along a predetermined direction, wherein the transfer of the kinetic energy into the fabric of space contracts the fabric of space along the predetermined direction. The method further includes transmitting radiant energy along the predetermined direction using the contracted fabric of space to achieve effective transit speeds that exceed the speed of light, as measured in the reference frame of the transmitter. The radiant energy may be electromagnetic energy or accelerated particles. The predetermined direction may be aligned with the direction in which accelerated protons are projected to induce the fusion reaction. The fusion reaction may be a hydrogen-lithium fusion reaction using any of the devices or methods described above. The magnetic field may be applied with field lines along the predetermined direction and a projected intersection with the location at which the fusion reaction is produced. Some of the helium ions produced by a hydrogen-lithium fusion reaction may be guided by the directed magnetic field and focused in the predetermined direction.

A corresponding device that harnesses energy from a fusion reaction to contract the fabric of space effectively transfers kinetic energy from the fusion reaction into the fabric of space. This device includes a beam of accelerated protons and a target comprising lithium. The target that is exposed to the proton beam, whereby fusion collisions between the accelerated protons and lithium atoms at a location create helium ions. The device further includes one or more magnets that apply a directed magnetic field with lines along a predetermined direction that is aligned to intersect the location of the fusion collisions. Operation of the device causes a region of a fabric of space to contract along the predetermined direction due to transfer of kinetic energy from the fusion reaction into the fabric of space. The device further includes an electromagnetic transmitter aligned with the contracted fabric of space. In operation, the electromagnetic transmitter takes advantage of the contracted fabric of space to effectively transmit electromagnetic radiation with transit speeds that appeared to exceed the speed of light when measured from the reference frame of the device.

Yet another different method that harnesses energy from a fusion reaction is a method for propelling a vessel using gravity exerted by units of the fabric of space. This method includes transferring kinetic energy from a fusion reaction generated on board a vessel into a region of the fabric of space along a predetermined direction. According to this method, the transfer of the kinetic energy into the fabric of space creates a gravitational attraction of the vessel in a predetermined direction.

An aspect of this method further includes contracting a region of the fabric of space along the predetermined direction and using the contracted fabric of space to decrease transit time, as measured in a pre-transit frame of reference.

A corresponding device that harnesses energy from a fusion reaction is a method for transferring kinetic energy into the fabric of space and contracting the fabric of space. This method includes a vessel and a beam of accelerated protons generated on board the vessel. It further includes a target comprising lithium carried by the vessel that is exposed to the proton beam, whereby fusion collisions between the accelerated protons and lithium atoms at a location create helium ions. The device further includes one or more magnets proximate to the target that apply a directed magnetic field with lines generally along the predetermined direction, aligned to intersect the location of the fusion collisions, whereby transfer of kinetic energy from the fusion collisions into a region of the fabric of space creates gravitational attraction of the vessel in the predetermined direction.

An aspect of this device, in operation, involves the helium ions spiraling around the magnetic field lines in the predetermined direction and transferring kinetic energy from the helium ions into the region of the fabric of space.

A further aspect of this device involves transfer of the kinetic energy into the region, thereby contracting the fabric of space along the predetermined direction, allowing the vessel to proceed through the contracted fabric of space with decreased transit time, as measured in a pre-transit frame of reference, for transit in the predetermined direction.

Yet another aspect of this device is a plurality of similar devices arrayed to provide the vessel with forward propulsion, steering, deceleration and reverse propulsion. The plurality of devices may further be arrayed to provide redundancy.

It is contemplated that modifications and combinations will readily occur to those skilled in the art, which modifications and combinations will be within the spirit of the invention and the scope of the following claims.

The following section reproduces a technical paper by the inventors describing their gravity theory.

We claim as follows:

1. A target assembly for use with a proton generator of the type capable of generating a proton beam along an axis, the proton beam having a transverse dimension at a target position, the target assembly including:
a target support locatable at the target position, wherein the target support has a minimum thickness, measured generally parallel to the axis, of at least 2.4 mm;
a lithium target having front and back surfaces supported by the target support, the target having a maximum target thickness, measured generally parallel to the axis, less than the first zero of the J₀ Bessel function times the gravity wavelength of the proton; and
the target support configured so that the target has exposed front and back target surfaces free of target support material, a projection of the exposed front surface onto the exposed back target surface defining the target area as an intersection between areas of the exposed front and back target area.

2. The assembly according to claim 1, wherein the first zero of the J₀ Bessel function is about 2.4 and the gravity wavelength of the proton is about 1 mm so that the maximum target thickness is less than about 2.4 mm.

3. The assembly according to claim 1, wherein the target support has a minimum thickness, measured generally parallel to the axis, equal to pi times the gravity wavelength of the proton.

4. The assembly according to claim 3, wherein the gravity wavelength of the proton is about 1 mm so that the target support has a minimum thickness of at least about 3.14 mm.

5. The assembly according to claim 1, wherein the target support has a minimum thickness, measured generally parallel to the axis, equal to the distance between 0 and the first zero of the J₀ Bessel function times the gravity wavelength of the proton.

6. The assembly according to claim 1, wherein the target support circumscribes the target area.

7. The assembly according to claim 1, wherein the target support is an aluminum target support.

8. The assembly according to claim 1, wherein the target support has front and back sides and the target is located midway between the front and back sides.

9. The assembly according to claim 1, wherein the target area is circular.

10. The assembly according to claim 1, wherein the target comprises at least one of metallic lithium and a lithium-containing material.

11. The assembly or according to claim 8, wherein the lithium-containing material comprises at least one of lithium oxide and a lithium alloy.

12. The assembly according to claim 1, wherein the target has a minimum transverse dimension of at least the transverse dimension of the proton beam plus 2 times the value of the first zero of the J₀ Bessel function times the gravity wavelength of the helium ion.

13. The assembly according to claim 12, wherein the value of the first zero of the J₀ Bessel function is about 2.4 and the gravity wavelength of the helium ion is about 4 mm.

14. In the assembly according to claim 1, wherein the target has a generally uniform thickness.

15. A target assembly for use with a proton generator of the type capable of generating a proton beam along an axis, the proton beam having a transverse dimension at a target position, the target assembly including:
a target support locatable at the target position;
the target support having a minimum thickness of at least about 3.14 mm measured generally parallel to the axis;
a lithium target having front and back surfaces supported by the target support, the target having a maximum target thickness of less than 2.4 mm measured generally parallel to the axis;
the target support configured so that:
the target has exposed front and back target surfaces free of target support material, a projection of the exposed front surface onto the exposed back target surface defining the target area as an intersection between areas of the exposed front and back target area; and
the target support circumscribes the target area; and
the target having a minimum transverse dimension of at least 19.2 mm plus the transverse dimension of the proton beam.

16. A method for making a target assembly for use with a proton generator of the type capable of generating a proton beam along an axis, the proton beam having a transverse dimension at a target position, the method including:
selecting a lithium target material having front and back surfaces, the target material at the target area having a maximum target thickness, measured generally parallel to the axis, less than a the value of the first zero of the J₀ Bessel function times the gravity wavelength of the proton;
choosing a target support to hold the target material, wherein the target support has a minimum thickness, measured generally parallel to the axis, of at least 2.4 mm;
mounting the target material to the target support to create a target assembly locatable at the target position; and
the selecting, choosing and mounting steps carried out so that the target assembly comprises a lithium target having exposed front and back target surfaces free of target support material, a projection of the exposed front surface onto the exposed back target surface defining the target area as an intersection between areas of the exposed front and back target area.

17. The method according to claim 16, wherein the first zero of the J₀ Bessel function is about 2.4 and the gravity wavelength of the proton is about 1 mm so that the maximum target thickness is less than about 2.4 mm.

18. The method according to claim 16, wherein the target support has a minimum thickness, measured generally parallel to the axis, equal to pi times the gravity wavelength of the proton.

19. The method according to claim 18, wherein the gravity wavelength of the proton is about 1 mm so that the target support has a minimum thickness of at least about 3.14 mm.

20. The method according to claim 16, wherein the target support has a minimum thickness, measured generally parallel to the axis, equal to the distance between 0 and the first zero of the J₀ Bessel function times the gravity wavelength of the proton.

21. The method according to claim 16, wherein the selecting step comprises selecting target material having a uniform thickness.

22. The method according to claim 16, wherein the selecting step selects target material including at least one of metallic lithium, lithium oxide and a lithium alloy.

23. The method according to claim 16, wherein the target support choosing step is carried out so that the target area is circular.

24. The method according to claim 16, wherein the target support choosing step is carried out so that the target support has a minimum thickness, measured generally parallel to the axis, less than the first zero of the J₀ Bessel function times the gravity wavelength of the proton.

25. The method according to claim 16, wherein the target support choosing step is carried out so that the target support has a minimum thickness of at least about 3.14 mm measured generally parallel to the axis.

26. The method according to claim 16, wherein the target support choosing step is carried out so that the target support is aluminum.

27. The method according to claim 16, wherein the target material mounting step is carried out so that the target material is located midway between the front and back of the target support

28. A method of producing sustained hydrogen-lithium fusion, according to claim 16, further including:
projecting the proton beam along the axis and fusing protons in the proton beam with lithium nuclei in the target area.

29. The method of claim 28, wherein the components of the target support have a minimum thickness of about 3.14 mm measured generally parallel to the axis and the hydrogen-lithium fusion is sustained for more than 10 minutes without melting the target material.
